(19) United States
(12) Patent Application Publication
(10) Pub. No.: US 2026/0297459 A1
(43) Pub. Date: Oct. 1, 2026

(54) Surfactant Potentiators for Ethoxylated Surfactants

(71) Applicant: ARXADA, LLC, Morristown, NJ (US)

(72) Inventors: Xiao Jiang, Morristown, NJ (US); David Binder, Morristown, NJ (US); Gladys Michelle Dimitriadis, Florham Park, NJ (US); Jake Jacobs, Florham Park, NJ (US)

(21) Appl. No.: 19/483,275

(22) PCT Filed: Jun. 18, 2024
(86) PCT No.: PCT/US2024/034490

§ 371 Date: Nov. 11, 2025

Related U.S. Application Data
(60) Provisional application No. 63/509,903, filed on Jun. 23, 2023.

(51) Int. Cl. C11D 1/62; C11D 1/12; C11D 1/44; C11D 3/28; C11D 3/37; C11D 3/48

(52) U.S. Cl. CPC C11D 1/62; C11D 1/123; C11D 1/44; C11D 3/28; C11D 3/3723; C11D 3/3757; C11D 3/3776; C11D 3/48; C11D 2111/12

(57) ABSTRACT

Provided herein are compositions containing at least one surfactant combined with at least one surfactant potentiator. The surfactant is an ethoxylated surfactant. In one aspect, the surfactant is an ethoxylated quaternary tertiary amine. In still another aspect, the surfactant is a mixture of an ethoxylated tertiary amine and an ethoxylated quaternary amine. The composition can be a fabric treatment, such as a laundry detergent.

### CROSS REFERENCE TO RELATED APPLICATIONS

This application claims priority to the benefit of U.S. Provisional Application No. 63/509,903, filed Jun. 23, 2024 which is expressly incorporated herein by reference in its entirety.

### BACKGROUND

Surface cleaning compositions are commercially important products and have broad utility in facilitating the removal of dirt, oily substances, contaminates, and impurities from surfaces, such as hard and soft surfaces. Such compositions can include disinfectant compositions, such as hard surface disinfectants, as well as compositions that are incorporated into premoistened wipes. Such compositions also include laundry detergents and other compositions designed to clean fabrics.

The removal of liquid, semi-solid, or solid organic soils and oily materials from a variety of substrates including hard surfaces and fabrics has been a problem posed to formulators of cleaning compositions for many years. A large variety of different surfactants have been proposed for the removal of such contaminants. In the past, most cleaning compositions designed to remove soils and oily substances contain one or more anionic surfactants. Although anionic surfactants are well suited for removing dirt and oily substances from surfaces, the use of anionic surfactants has various drawbacks. For example, anionic surfactants can be incompatible with antimicrobial agents, particularly cationic antimicrobial agents. Consequently, many anionic surfactants are not used in disinfectant compositions. When used in laundry detergents, the anionic surfactants can greatly reduce the efficacy of antimicrobial agents present in the composition.

In view of the above, a need exists for a surfactant composition capable of removing oily substances and soils from adjacent surfaces while also being compatible with various different antimicrobial agents. In one aspect, a need exists for a cationic surfactant that can be blended with antimicrobial agents and that can be formulated to display the ability to clean and/or remove solid particulate material and oily substances.

A need also exists for a fabric treatment, such as a laundry detergent, that contains a surfactant that is not only well suited to cleaning fabrics but is also compatible with disinfectants. A need also exists for a surfactant that can be incorporated into fabric treatments that is also compatible with other surfactants contained in the composition.

### SUMMARY

In general, the present disclosure is directed to a surfactant composition or formulation that is not only compatible with antimicrobial agents but is also well suited to cleaning or removing oily substances and soils from surfaces, such as hard surfaces or textiles. The surfactant composition or formulation contains one or more surfactants in combination with one or more surfactant potentiators. The surfactant potentiator improves the ability of the one or more surfactants to remove soils and/or oily substances from a surface while also being compatible with antimicrobial agents, such as quaternary ammonium compounds.

The composition of the present disclosure contains one or more surfactants. The surfactants can lower the surface tension and increase the wetting properties of the composition. One or more surfactants are selected in accordance with the present disclosure that can also significantly improve the cleaning properties of the composition without interfering with the efficacy of one or more antimicrobial agents. In fact, in one embodiment, the surfactant can actually enhance the antimicrobial activity of the composition. The one or more surfactants in accordance with the present disclosure can be incorporated into various different types of compositions. The composition, for instance, can be a hard surface cleaner/disinfectant or can be a fabric treatment, such as a laundry detergent.

In one embodiment, the present disclosure is directed to a composition comprising one or more surfactants combined with one or more surfactant potentiators and optionally with one or more antimicrobial agents. The one or more surfactants can comprise:
an ethoxylated tertiary amine of the general formula (I):

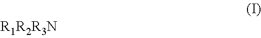

an ethoxylated quaternary amine of the general formula (II):

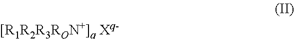

or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

In one aspect, p is 0, and Ra, Rb, Rc, Rd, Re, and Rf are hydrogen.

In one aspect, R1 comprises greater than 70%, such as greater than about 80%, such as greater than about 90% of an unsubstituted C18 hydrocarbon.

In one aspect, R1 comprises less than 20% of hydrocarbons having a carbon chain length of 16 carbon atoms or less, comprises from about 80% to about 95% of an unsubstituted C18 hydrocarbon, and comprises less than 5% of hydrocarbons having a carbon chain length of greater than 18 carbon atoms.

In another aspect, R1 comprises from about 40% to about 65% of an unsubstituted C12 hydrocarbon, comprises from about 10% to about 25% of an unsubstituted C14 hydrocarbon, comprises from about 5% to about 18% of an unsubstituted C16 hydrocarbon, comprises from about 4% to about 15% of an unsubstituted C18 hydrocarbon, comprises from about 1% to about 10% of an unsubstituted C10 hydrocarbon, and comprises from about 0% to about 8% of an unsubstituted C8 hydrocarbon. Each hydrocarbon above can be saturated, unsaturated, or a mixture of saturated and unsaturated hydrocarbons. In one embodiment, the C18 hydrocarbon comprises 1% to 5% of a saturated and 4% to 8% of an unsaturated. Alternatively, the C18 hydrocarbon is comprised entirely of a saturated.

In the formulas above, n+m equals the total mols of R2 and R3 groups, such as the total mols of ethoxylate groups of R2 and R3 groups. As used herein, the total mols of ethoxylate groups of R2 and R3 groups is an average and can be calculated based on the reactants used to produce the molecules or can be determined using NMR spectroscopy.

In one aspect, the composition only contains one or more surfactants comprising an ethoxylated quaternary amine of the general formula (II). In another aspect, the one or more surfactants comprises only an ethoxylated tertiary amine of the general formula (I). In still another embodiment, the one or more surfactants comprise a mixture of an ethoxylated quaternary amine of the general formula (II) and an ethoxylated tertiary amine of the general formula (I). In one aspect, for instance, the mixture can comprise from about 5% by weight to about 80% by weight of at least one ethoxylated quaternary amine and from about 95% by weight to about 20% by weight of at least one ethoxylated tertiary amine. In another aspect, the mixture can comprise from about 5% by weight to about 35% by weight of at least one ethoxylated quaternary amine and from about 95% by weight to about 65% by weight of at least one ethoxylated tertiary amine.

In one embodiment, the surfactant comprises a quaternary ethoxylated fatty amine. In another embodiment, the surfactant comprises a tertiary ethoxylated fatty amine. In still another embodiment, the surfactant comprises a mixture of a tertiary ethoxylated fatty amine and a quaternary ethoxylated fatty amine. Particular embodiments of the surfactant or mixture of surfactants include a quaternary ethoxylated stearyl-2-hydroxyethylamine, chloride containing from about 8 mols to about 30 mols of ethoxylate; a tertiary ethoxylated stearyl-2-hydroxyethylamine containing from about 8 mol to about 30 mol of ethoxylate; a mixture of quaternary ethoxylated stearyl-2-hydroxyethylamine, chloride containing from about 8 mols to about 30 mols of ethoxylate and of a tertiary ethoxylated stearyl-2-hydroxyethylamine containing from about 8 mol to about 30 mol of ethoxylate; a quaternary ethoxylated cocoalkyl-2-hydroxyethylamine, chloride containing from about 8 mols to about 30 mols of ethoxylate; a tertiary ethoxylated cocoalkyl-2-hydroxyethylamine containing from about 8 mols to about 30 mols of ethoxylate; or a mixture of a quaternary ethoxylated cocoalkyl-2-hydroxyethylamine, chloride containing from about 8 mols to about 30 mols of ethoxylate and of a tertiary ethoxylated cocoalkyl-2-hydroxyethylamine containing from about 8 mols to about 30 mols of ethoxylate. The surfactant can be non-biocidal.

As described above, the one or more surfactants are combined with one or more surfactant potentiators. The surfactant potentiator can comprise a morpholine, a vinyl pyrrolidone copolymer, a polyacrylate crosspolymer, a polyalkyleneimine, an alkyl polyglucoside, a salt of an alkyl or an alkylene ester or diester of a sulfosuccinic acid, or mixtures thereof.

For example, in one aspect, the surfactant potentiator can comprise a morpholine, such as an alkylmorpholine. The morpholine, for instance, can be a C₆ to C₂₄ alkylmorpholine, such as a C₈ to C₂₀ alkylmorpholine, such as a C₁₀ to C₁₆ alkylmorpholine. In one aspect, the surfactant potentiator comprises 4-laurylmorpholine, 4-tetradecylmorpholine, 4-hexadecylmorpholine, or mixtures thereof.

In another aspect, the surfactant potentiator comprises a vinyl pyrrolidone copolymer, such as a vinyl pyrrolidone and dialkylaminoethyl copolymer. In one aspect, the surfactant potentiator comprises dimethylaminoethyl methacrylate vinyl pyrrolidone.

In still another aspect, the surfactant potentiator comprises a polyacrylate crosspolymer, such as an amine substituted polyacrylate crosspolymer. The surfactant potentiator, for instance, can comprise polyacrylate-1 crosspolymer.

In still another aspect, the surfactant potentiator can comprise the polyalkyleneimine, such as a polyethyleneimine. In one aspect, the surfactant potentiator comprises a branched polyethyleneimine.

In still another aspect, the surfactant potentiator comprises an alkyl polyglucoside, which can be the reaction product of glucose and a fatty alcohol. Examples of alkyl polyglucosides include C₆ to C₂₄ alkyl polyglucosides, such as C₈ to C₁₀ alkyl polyglucosides. The alkyl polyglucoside can have a degree of polymerization of from about 1.3 to about 1.8, such as from about 1.4 to about 1.8.

In still another embodiment, the surfactant potentiator comprises the salt of an alkyl or alkenyl ester or diester of a sulfosuccinic acid. For instance, the surfactant potentiator can comprise an alkali metal, ammonium, calcium, or magnesium salt of an alkyl or alkylene ester or diester of a sulfosuccinic acid. In one aspect, the surfactant potentiator comprises sodium dioctyl sulfosuccinate or disodium dioctyl sulfosuccinate.

The one or more surfactants can be present in relation to the one or more surfactant potentiators at a weight ratio of from about 50:1 to about 1:10, such as from about 20:1 to about 1:5, such as from about 15:1 to about 1:1. The one or more surfactant potentiators, for instance, can be present in the composition in an amount greater than about 10 ppm, such as in an amount greater than about 20 ppm, such as in an amount greater than about 50 ppm, such as in an amount greater than about 70 ppm, such as in an amount greater than about 100 ppm, such as in an amount greater than about 150 ppm, such as in an amount greater than about 200 ppm, and in an amount less than about 10,000 ppm, such as in an amount less than about 5,000 ppm, such as in an amount less than about 1,000 ppm.

The composition can be formulated as a ready-to-use composition or can be formulated as a liquid concentrate that is diluted prior to use. The surfactant can be present in a ready-to-use composition in an amount of greater than about 1 ppm, such as greater than about 10 ppm, such as greater than about 50 ppm, such as greater than about 100 ppm, such as greater than about 200 ppm, and generally in an amount less than about 1,000,000 ppm, such as in an amount less than about 50,000 ppm, such as in an amount less than about 25,000 ppm.

As described above, the composition of the present disclosure can optionally contain one or more antimicrobial agents. In one aspect, the antimicrobial agent can comprise one or more quaternary ammonium compounds. The quaternary ammonium compounds can have the following structure:

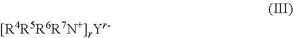

wherein
R⁴ is an optionally substituted benzyl group or an optionally substituted alkyl or aryl-substituted alkyl group;
R⁵ and R⁶ are independently optionally substituted alkyl groups;
R⁷ is selected from the group consisting of an optionally substituted alkyl or aryl-substituted alkyl group, benzyl group, and —[(CH₂)₂—O]ₙ—R⁸, wherein n is an integer from 1 to 20 and R⁸ is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.

Examples of quaternary ammonium compounds that can be incorporated into the composition include an alkyl dimethyl benzyl ammonium chloride, at least one dimethyl dialkyl ammonium chloride, or an alkyl trimethyl ammonium compound. Particular examples of quaternary ammonium compounds that can be present in the composition include didecyl dimethyl ammonium chloride, an N,N-dialkyl-N,N-dimethylammonium carbonate and/or N,N-dialkyl-N,N-dimethylammonium bicarbonate, N,N-didecyl-N-methyl-poly(oxyethyl) ammonium propionate, octyl decyl dimethyl ammonium chloride, dioctyl dimethyl ammonium chloride, didecyl dimethyl ammonium chloride, tetradecane dimethyl benzyl ammonium chloride, dodecane dimethyl benzyl ammonium chloride, hexadecane dimethyl benzyl ammonium chloride, and a trimethylhexadecyl ammonium ion.

The one or more antimicrobial agents can be present in the composition in an amount less than about 1,000 ppm, such as in an amount less than about 500 ppm, such as in an amount less than about 250 ppm, such as in an amount less than about 100 ppm, such as in an amount less than about 50 ppm, such as even in an amount less than about 20 ppm. When the antimicrobial agent comprises one or more quaternary ammonium compounds, the antimicrobial agent can be present in an amount from about 1 ppm to about 500 ppm, while the surfactant can be present in an amount from about 10 ppm to about 5,000 ppm.

In addition to quaternary ammonium compounds, various other antimicrobial agents can be present in the composition. For instance, in one embodiment, the composition contains chlorhexidine. The chlorhexidine can be present alone or in combination with one or more quaternary ammonium compounds. When present, the chlorhexidine can be included in the ready-to-use composition in an amount from about 1 ppm to about 500 ppm.

The composition can also contain an amine, such as a tertiary amine. The amine can comprise bis(3-aminopropyl) dodecylamine. The amine can be present alone or in combination with chlorhexidine and/or one or more quaternary ammonium compounds. When present, the chlorhexidine can be included in the ready-to-use composition in an amount from about 1 ppm to about 2000 ppm.

As described above, the surfactant of the present disclosure can be included in the composition without adversely interfering with the efficacy of the antimicrobial agent. For instance, the composition can be formulated to exhibit a log reduction against a microorganism and wherein the log reduction is no less in comparison to an identical composition containing the one or more antimicrobial agents but not containing the surfactant. The microorganisms, for instance, can be Pseudomonas aeruginosa or Candida albicans.

In another aspect, the present disclosure is directed to a fabric treatment, such as a laundry detergent, containing one or more surfactants and one or more surfactant potentiators as described above. The one or more surfactants and one or more surfactant potentiators can be incorporated into the laundry detergent with or without an antimicrobial agent.

For example, in one aspect, the present disclosure is directed to a fabric treatment comprising a laundry detergent composition. The laundry detergent composition comprises a laundry detergent surfactant combined with one or more cationic surfactants and one or more surfactant potentiators.

The laundry detergent surfactant, for instance, can comprise an alcohol alkoxylate, an alcohol ethoxy sulfate, an amine oxide, a monoethanolamine alkylbenzenesulfonate, a monoethanolamine alkyl benzene sulfonic acid, a monoethanolamine laureth sulfate, a sodium alkylbenzene sulfonate, a sodium lauryl sulfate, or mixtures thereof. The fabric treatment can also contain an enzyme, a fatty acid component, a perfume, a chelant, a radical scavenger, a soil release polymer, a soil suspension polymer, a whiting agent, a rheology modifier, or mixtures thereof.

In another aspect, the present disclosure is directed to a product comprising a liquid absorbent substrate and a composition contained or absorbed into the substrate that comprises a surfactant, one or more surfactant potentiators, and optionally an antimicrobial agent as described above. The liquid absorbent substrate can comprise a woven fabric, a knitted fabric, or a nonwoven web. The nonwoven web can comprise a meltblown web, a coform web, a spunbond web, an airlaid web, an airlaced web, a hydroentangled web, a bonded carded web, or any laminate thereof.

In still another aspect, the present disclosure is directed to a method for destroying microorganisms on an adjacent surface. The method includes saturating a liquid absorbent substrate with a composition containing a surfactant, one or more surfactant potentiators, and at least one antimicrobial agent as described above. The saturated liquid absorbent substrate is then applied to a surface. The microorganism destroyed during the method can be a virus, a bacteria, a fungi, a yeast, an algae, a slime, or any combination thereof.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying FIGURE, in which:

FIG. 1 is a graphical representation of some of the results obtained in the examples below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

The present disclosure is generally directed to a composition containing one or more surfactants blended with one or more surfactant potentiators. The surfactant potentiators are selected so as to be compatible with the one or more surfactants. In one aspect, the surfactant potentiators, once blended with one or more of the surfactants, can dramatically improve the ability of the one or more surfactants to clean hard and soft surfaces. In particular, the one or more surfactant potentiators are particularly well suited to removing dirt, contaminants, soil, and oily substances from a hard or soft surface.

The one or more surfactants of the present disclosure are particularly well suited for use in conjunction with various different antimicrobial agents. The one or more surfactants, which can be cationic surfactants, for instance, can be blended with antimicrobial agents for producing a composition that not only has enhanced cleaning abilities but also does so without interfering with the efficacy of the antimicrobial agents. The surfactant potentiators of the present disclosure can also be selected so as to not interfere with the efficacy of the antimicrobial agents and, in one embodiment, can actually be used in conjunction with the one or more surfactants for enhancing the ability of the antimicrobial agents to destroy or inhibit the growth of microorganisms.

A composition in accordance with the present disclosure containing one or more surfactants in combination with one or more surfactant potentiators can be incorporated into all different types of products. For instance, the composition can be incorporated into disinfectants that are applied to hard surfaces or incorporated into a premoistened substrate for wiping surfaces. The composition of the present disclosure containing a blend of one or more surfactants and one or more surfactant potentiators can also be incorporated into all different types of fabric treatments. The fabric treatment, for instance, can be a laundry detergent, a rinse solution, a fabric softener, an upholstery cleaner, or the like. When incorporated into a fabric treatment, the composition can optionally contain one or more antimicrobial agents.

When incorporated into a disinfectant composition, the composition has numerous uses and applications. For example, the composition can be used to disinfect all surfaces, including hard and soft surfaces. The composition, for instance, may comprise a hard surface disinfectant, a hand sanitizer, a sterilizing or high-level disinfectant composition, a pre-disinfectant cleaner for instruments, a soft surface disinfectant composition, an upholstery or fabric cleaner/disinfectant, or the like. The composition, for instance, can be used in the food and beverage field for cleaning food contact surfaces, such as counters, food service tables, food containers, and the like. In addition, the composition is also particularly well suited for use in the health field, such as in hospitals, emergency care centers, doctor and dentist offices, and the like.

In another aspect, the present disclosure is directed to methods for destroying microorganisms on a surface. For example, the composition can contain at least one antimicrobial agent in combination with one or more surfactants and one or more surfactant potentiators wherein the antimicrobial agent is at a concentration sufficient to destroy and kill many different types of microorganisms including viruses. Of particular advantage, the one or more surfactants and one or more surfactant potentiators can offer various advantages and benefits to the composition without significantly impacting the efficacy of the one or more antimicrobial agents. Thus, the concentration of the one or more antimicrobial agents can be minimized while still providing a composition sufficient to destroy all different types of microorganisms, including bacteria, fungi, yeast, algae, viruses, and the like.

The one or more surfactants and one or more surfactant potentiators contained within the composition can lower the surface tension. In addition, the surfactants and one or more surfactant potentiators can significantly improve the wetting and/or cleaning properties of the composition when applied to an adjacent surface. In this manner, the one or more surfactants or one or more surfactant potentiators enhance the action of the one or more antimicrobial agents by providing a more uniform and more effective contact against a surface. In addition, the one or more surfactants or one or more surfactant potentiators can also disperse the one or more antimicrobial agents within the composition, such as by dispersing the one or more antimicrobial agents better in a water-based solution.

Compositions of the present disclosure can result in increased antimicrobial efficacy at minimum concentrations while providing a composition that can have enhanced wetting and cleaning properties. Compositions of the present disclosure can be incorporated into products that offer both cleaning and disinfect characteristics thus resulting in a single product with multiple benefits. The composition of the present disclosure can contain all different types of antimicrobial agents. For example, the composition is particularly well suited to containing one or more quaternary ammonium compounds either alone or in combination with other antimicrobial agents. The composition of the present disclosure is also well suited for use with guanidine antimicrobial agents. In one particular embodiment, a quaternary ammonium compound can be combined with a guanidine antimicrobial agent.

In an alternative embodiment, the one or more surfactants and one or more surfactant potentiators of the present disclosure can be incorporated into a fabric treatment. The fabric treatment, for instance, can be a laundry detergent composition, a fabric rinse, or the like. The one or more surfactants and one or more surfactant potentiators of the present disclosure can be incorporated into the fabric treatment for enhancing the removal of dirt, stains, oily substances, and the like from fabrics. Because the one or more surfactants and one or more surfactant potentiators are compatible with various antimicrobial agents, the fabric treatment can optionally also contain one or more antimicrobial agents. In this manner, the fabric treatment can be used to clean and/or disinfect fabrics, clothing, and other textile materials. The fabric treatment, for instance, can include the one or more surfactants and one or more surfactant potentiators in accordance with the present disclosure combined with at least one laundry detergent surfactant. The fabric treatment can also contain an enzyme, a perfume, a chelant, a radical scavenger, a soil release polymer, a soil suspension polymer, a whiting agent, a rheology modifier, or mixtures thereof.

The one or more surfactants of the present disclosure can comprise a cationic or nonionic surfactant and/or a heavily alkoxylated surfactant that has been found to unexpectedly improve the ability of the composition to wet or clean adjacent surfaces without significantly affecting the efficacy of the one or more antimicrobial agents. When combined with one or more surfactant potentiators, the resulting blend has also been found to have excellent cleaning properties. In particular, the presence of the one or more surfactant potentiators has been found to dramatically improve the ability of the one or more surfactants to clean and/or remove soils, dirts, contaminants, oily substances, and the like.

In one aspect, the surfactant of the present disclosure can comprise one or more ethoxylated tertiary amines, one or more ethoxylated quaternary amines, or a mixture containing one or more ethoxylated tertiary amines combined with one or more ethoxylated quaternary amines. The amine that forms the backbone of the surfactant can comprise a fatty amine, such as a fatty amine containing about 6 to about 28 carbon atoms. The one or more potentiators blended with the one or more surfactants, on the other hand, can comprise a morpholine, a vinyl pyrrolidone copolymer, a polyacrylate crosspolymer, a polyalkyleneimine, an alkyl polyglucoside, a salt of an alkyl or alkenyl ester or diester of a sulfosuccinic acid, or mixtures thereof.

In one aspect, for instance, the one or more surfactants can be an ethoxylated tertiary amine. The ethoxylated tertiary amine can comprise an ethoxylated fatty amine. As used herein, an “ethoxylated fatty amine” refers to a fatty amine compound that has two ethoxylated arms. The ethoxylated tertiary amine, for instance, may have the following general formula (I):

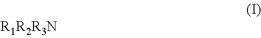

wherein,
R₁ is a linear or branched, saturated or unsaturated, aliphatic or aromatic, substituted or unsubstituted C6 to C24 hydrocarbon or a mixture thereof,
R₂ is a group of formula (CHRₐ—CHR_{b}—O)ₙH;
R₃ is a group of formula (CHR_{c}—CHR_{d}—O)ₘH;
n and m are an integer of from 2 to 60, with the proviso that n and m are independently the same or different,
Rₐ, R_{b}, R_{c}, R_{d}, Rₑ, R_{f} are independent of each other and comprise H, a methyl group, or a CH₂OH group.

Examples of ethoxylated tertiary amines include ethoxylated tallow amine, ethoxylated lauryl amine, ethoxylated cocoalkyl amine, ethoxylated stearyl amine, ethoxylated oleyl amine, and mixtures thereof. In one aspect, for instance, the ethoxylated tertiary amine can comprise an ethoxylated stearyl amine, an ethoxylated cocoalkyl amine, or mixtures thereof.

The number of ethoxylate groups present in the ethoxylated tertiary amine can generally be greater than about 4, such as greater than about 5, such as greater than about 6, such as greater than about 7, such as greater than about 8, and less than about 40, such as less than about 30, such as less than about 26, such as less than about 22, such as less than about 18, such as less than about 14, such as less than about 12.

The two ethoxylate chains contained within the ethoxylated tertiary amine can be symmetrical with respect to the fatty amine or can be different. In one aspect, Rₐ, R_{b}, R_{c}, and R_{d} can all be hydrogen.

In another aspect, the at least one surfactant can comprise an ethoxylated quaternary amine. The ethoxylated quaternary amine, for instance, can comprise a quaternary fatty amine ethoxylate.

As used herein, a “quaternary fatty amine ethoxylate” refers to a quaternary ammonium compound that has two ethoxylated arms and further comprises a saturated or unsaturated, aliphatic or aromatic, substituted or unsubstituted C6 to C24 hydrocarbon or a mixture thereof.

In one particular embodiment, the surfactant can include two alkoxylate chains and can have the following structure:

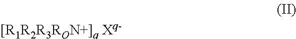

wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

In one aspect, the ethoxylated quaternary amine can be formed by quaternizing the ethoxylated tertiary amine to form the ethoxylated quaternary amine or a mixture of an ethoxylated quaternary amine and the ethoxylated tertiary amine. Thus, R₁, R₂, R₃, n, m, Rₐ, R_{b}, R_{c}, and R_{d} can have the same values or groups for the ethoxylated tertiary amine and for the ethoxylated quaternary amine.

As shown above, n together with m represents the total mols of ethoxylate groups present in R₂ and R₃ groups. In general, n and m can independently be greater than about 4, such as greater than about 5, such as greater than about 6, such as greater than about 7, such as greater than about 8. N and m are generally less than about 40, such as less than about 30, such as less than about 26, such as less than about 22, such as less than about 18, such as less than about 14, such as less than about 12. In one aspect, R₂ and R₃ groups can contain a total amount of ethoxylate groups (average) of greater than about 8 mols of ethoxylate groups, such as greater than about 10 mols of ethoxylate groups, such as greater than about 12 mols of ethoxylate groups, and less than about 30 mols of ethoxylate groups, such as less than about 26 mols of ethoxylate groups, such as less than about 24 mols of ethoxylate groups.

As shown above, the ethoxylated quaternary amine can also include a counterion that can be generated from a mineral acid or an organic acid. Examples of acids include hydrochloric acid, hydrobromic acid, nitric acid, phosphoric acid, sulfuric acid, boric acid, hydrofluoric acid, perchloric acid, formic acid, acetic acid, 2-ethylhexanoic acid, lactic acid, and the like.

In one aspect, the two alkoxylate chains can be identical or can be different.

In one aspect, p is 0. In one aspect, Rₐ, R_{b}, R_{c}, R_{d}, Rₑ, and R_{f} are all hydrogen.

The surfactants described above contain a fatty amine. The fatty amine, in one aspect, can be obtained from animal-based oils and fats derived from beef tallow, fish oil, lanolin, and the like. The fatty amine can also be obtained from plant-based oils and fats, such as those derived from coconut oil, palm oil, soybean oil, and the like. The fatty amine can also be a synthetic molecule.

The fatty acid portion of the molecule can be saturated or unsaturated. The fatty acid, for instance, can have a carbon chain length of greater than about 4 carbon atoms, such as greater than about 6 carbon atoms, such as greater than about 8 carbon atoms, and generally less than about 28 carbon atoms, such as less than about 26 carbon atoms, such as less than about 24 carbon atoms, such as less than about 22 carbon atoms, such as less than about 20 carbon atoms. Suitable alkyl- or alkenyl-fatty groups contained in the fatty amine, for instance, may include hexyl, heptyl, n-octyl, p-tert. octyl, n-nonyl-, p-tert. nonyl, decyl, lauryl, tridecyl, myristyl, palmityl, stearyl, arachidyl, hydroabietyl or behenyl, 2-ethylhexyl, 2-propylheptyl, linolenyl, stearidonyl, linoleyl, arachidonyl, palmitoleyl, oleyl, elaidyl, tallow alkyl, hydrogenated tallow alkyl, rape seed alkyl, soya alkyl, coco alkyl and the like.

The surfactants of the present disclosure can be characterized by having two alkoxylate chains, such as two ethoxylate chains, that have the same length or a similar length. Particular examples of the surfactant or mixture of surfactants well suited for use in the composition include a quaternary ethoxylated stearyl-2-hydroxyethylamine, chloride containing from about 8 mols to about 30 mols of ethoxylate; a tertiary ethoxylated stearyl-2-hydroxyethylamine containing an average of from about 8 mol to about 30 mol of ethoxylate; a mixture of quaternary ethoxylated stearyl-2-hydroxyethylamine, chloride containing from about 8 mols to about 30 mols of ethoxylate and of a tertiary ethoxylated stearyl-2-hydroxyethylamine containing an average of from about 8 mol to about 30 mol of ethoxylate; a quaternary ethoxylated cocoalkyl-2-hydroxyethylamine, chloride containing an average of from about 8 mols to about 30 mols of ethoxylate; a tertiary ethoxylated cocoalkyl-2-hydroxyethylamine containing from about 8 mols to about 30 mols of ethoxylate; or a mixture of a quaternary ethoxylated cocoalkyl-2-hydroxyethylamine, chloride containing an average of from about 8 mols to about 30 mols of ethoxylate and of a tertiary ethoxylated cocoalkyl-2-hydroxyethylamine containing an average of from about 8 mols to about 30 mols of ethoxylate.

The chemical structure of the surfactants as shown above (both the ethoxylated tertiary amine and the ethoxylated quaternary amine surfactants) includes an alkyl group R₁. The surfactant of the present disclosure can include a single R₁ group having the same carbon chain length or can include a mixture of R₁ groups that have different carbon chain lengths. In general, R₁ can have a carbon chain length of greater than about 4 carbon atoms, such as greater than about 8 carbon atoms, such as greater than about 10 carbon atoms, such as greater than about 12 carbon atoms, such as greater than about 14 carbon atoms. The carbon chain length of R₁ is generally less than about 28 carbon atoms, such as less than about 26 carbon atoms, such as less than about 24 carbon atoms, such as less than about 22 carbon atoms, such as less than about 20 carbon atoms.

In one aspect, the surfactant incorporated into the composition whether an ethoxylated tertiary amine or an ethoxylated quaternary amine of the present disclosure has an R₁ distribution such that greater than about 70%, such as greater than about 75%, such as greater than about 80%, such as greater than about 85%, such as greater than 90%, such as greater than 95%, and up to about 100%, such as less than about 95% of the R₁ groups have a carbon chain length of 18 carbon atoms. In this embodiment, the surfactant can include an R₁ distribution such that less than about 18%, such as less than about 15%, such as less than about 12% of the R₁ groups have a carbon chain length of 16 carbon atoms or less. The R₁ distribution can also include R₁ groups having a chain length of greater than 18 carbon atoms in an amount less than about 5%, such as in amounts less than about 3%. The surfactant can contain generally from about 10 ethoxylate groups to about 40 ethoxylate groups, such as from about 12 ethoxylate groups to about 22 ethoxylate groups.

In another aspect, the R1 groups contained in the surfactant can have a broader and more varied carbon chain length distribution. For instance, the surfactant can contain R1 groups having a carbon chain length of 8 carbon atoms in an amount greater than about 1%, such as in an amount greater than about 2%, such as in an amount greater than about 3%, and in an amount less than about 8%, such as in an amount less than about 6%, such as in an amount less than about 5%. The surfactant can contain R1 groups having a carbon chain length of 10 carbon atoms in an amount greater than about 2%, such as in an amount greater than about 3%, such as in an amount greater than about 4%, and in an amount less than about 8%, such as in an amount less than about 7%, such as in an amount less than about 6%. The surfactant can contain R1 groups having a carbon chain length of 12 carbon atoms in an amount greater than about 40%, such as in an amount greater than about 45%, such as in an amount greater than about 50%, such as in an amount greater than about 52%, and in an amount less than about 65%, such as in an amount less than about 60%, such as in an amount less than about 58%. The surfactant can contain R1 groups having a carbon chain length of 14 carbon atoms in an amount greater than about 10%, such as in an amount greater than about 12%, such as in an amount greater than about 16%, and in an amount less than about 26%, such as in an amount less than about 24%, such as in an amount less than about 20%. The surfactant can contain R1 groups having a carbon chain length of 16 carbon atoms in an amount greater than about 4%, such as in an amount greater than about 6%, such as in an amount greater than about 8%, and in an amount less than about 18%, such as in an amount less than about 16%, such as in an amount less than about 14%, such as in an amount less than about 12%. The surfactant can contain R1 groups having a carbon chain length of 18 carbon atoms in an amount greater than about 4%, such as in an amount greater than about 6%, such as in an amount greater than about 8%, and in an amount less than about 18%, such as in an amount less than about 16%, such as in an amount less than about 14%, such as in an amount less than about 12%. Each hydrocarbon above can be saturated, unsaturated, or a mixture of saturated and unsaturated hydrocarbons. In one embodiment, the C18 hydrocarbon comprises 1% to 5% of a saturated hydrocarbon and 4% to 8% of an unsaturated hydrocarbon. Alternatively, the C18 hydrocarbon is comprised entirely of a saturated hydrocarbon.

The surfactant, such as the ethoxylated quaternary amine or the ethoxylated tertiary amine, can have a molecular weight (MW) of greater than about 600 g/mol, such as greater than about 700 g/mol, such as greater than about 750 g/mol, such as greater than about 800 g/mol. The molecular weight can be less than about 3,000 g/mol, such as less than about 2,000 g/mol, such as less than about 1,500 g/mol, such as less than out 1,400 g/mol, such as less than about 1,300 g/mol, such as less than about 1,200 g/mol.

In accordance with the present disclosure, one or more surfactants as described above, are combined with one or more surfactant potentiators. The surfactant potentiators dramatically enhance the ability of the one or more surfactants to clean surfaces, such as hard or soft surfaces, including fabrics. For instance, the one or more surfactant potentiators can significantly enhance the ability of the one or more surfactants to remove soils, dirt, contaminants, oily substances, and the like. When the composition is optionally formulated to also contain one or more antimicrobial agents, the one or more potentiators can also be selected so as to not interfere with the efficacy of the antimicrobial agents.

As described above, the one or more surfactant potentiators can comprise a morpholine, a vinyl pyrrolidone copolymer, a polyacrylate crosspolymer, a polyalkyleneimine, an alkylpolyglucoside, a salt of an alkyl or alkenyl ester or diester of a sulfosuccinic acid, or mixtures thereof.

For instance, in one aspect, the surfactant potentiator can comprise a morpholine, such as an alkyl morpholine. The morpholine, for instance, may have the following general formula:

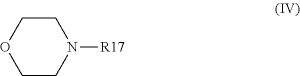

wherein R17 may be a linear, branched, cyclic, or any combination thereof of a C₁₋₄₀ saturated or unsaturated group, such as a C₁₋₂₀ saturated or unsaturated group or a C₆₋₄₀ saturated or unsaturated group, such as a C₁₋₁₀ saturated or unsaturated group or a C₆₋₂₂ saturated or unsaturated group, such as a C₁₋₅ saturated or unsaturated group or such as a C₈₋₁₈ saturated or unsaturated group. R17 may be an alkyl group, an alkenyl group, an alkynyl group, a hydroxyalkyl group, an alkoxy group, or an aminoalkyl group.

In one embodiment, the compound of Formula (IV) may be a C6-C24 alkylmorpholine, such as a C8-C20 alkylmorpholine, such as a C10-C16 alkylmorpholine, or any combination thereof. In one embodiment, R17 may be an alkyl group such as a C12 alkyl.

It should be understood that the morpholine identified by Formula (IV) may also be a substituted morpholine wherein the H atoms on the carbons of the morpholine heterocycle are replaced or substituted. For instance, substitution may occur at the 2, 3, 5, and/or 6 positions of the morpholine heterocycle. For instance, the morpholine may have a second group branching from the morpholine heterocycle in addition to the R17 group as identified above. The second group may be a linear, branched, cyclic, or any combination thereof of a C₁₋₄₀ saturated or unsaturated group, such as a C₁₋₂₀ saturated or unsaturated group or a C₆₋₄₀ saturated or unsaturated group, such as a C₁₋₁₀ saturated or unsaturated group or a C₆₋₂₂ saturated or unsaturated group, such as a C₁₋₅ saturated or unsaturated group or a C₁₀₋₂₀ saturated or unsaturated group, such as a C₁₅₋₂₀ saturated or unsaturated group. This second group may be an alkyl group, an alkenyl group, an alkynyl group, a hydroxyalkyl group, an alkoxy group, or an aminoalkyl group.

The morpholine may be a morpholine derivative such that the R17 group is attached to the N in the morpholine heterocycle. As such, the R17 group may be attached to the 4-position of the heterocycle.

In one aspect, the morpholine can be a C₆-C₂₄ alkyl morpholine, such as a C₈-C₂₀ alkyl morpholine, such as a C₁₀-C₁₆ alkyl morpholine. The composition can contain a single alkyl morpholine or can contain a mixture of alkyl morpholines. Particular alkyl morpholines that may be incorporated include 4-laurylmorpholine, 4-tetradecylmorpholine, and 4-hexadecylmorpholine. In one aspect, the surfactant potentiator comprises a combination of the alkyl morpholines described above.

In another aspect, the surfactant potentiator may comprise a vinyl pyrrolidone copolymer, such as a random copolymer of a vinyl pyrrolidone. The vinyl pyrrolidone copolymer can be nonionic or cationic.

In one particular embodiment, the vinyl pyrrolidone copolymer can be a vinyl pyrrolidone and dialkylaminoethyl copolymer. For instance, the surfactant potentiator may comprise a dimethylaminoethyl methacrylate vinyl pyrrolidone copolymer. The copolymer can have a molecular weight of generally greater than about 50,000 g/mol, such as greater than about 100,000 g/mol, such as greater than about 200,000 g/mol, and less than about 1,000,000 g/mol, such as less than about 800,000 g/mol, such as less than about 600,000 g/mol, such as less than about 400,000 g/mol.

In still another embodiment, the surfactant potentiator may comprise a polycarboxylic acid compound, particularly a polyacrylate crosspolymer. The polyacrylate crosspolymer, for instance, can be amine substituted. In one aspect, the polyacrylate crosspolymer comprises polyacrylates-1 crosspolymer.

In one aspect, the surfactant potentiator can comprise a polyalkyleneimine, particularly a polyethyleneimine. The polyalkyleneimine or the polyethyleneimine can be cationic and can have a branched structure.

In one aspect, the polyethyleneimines are defined by the following formula:

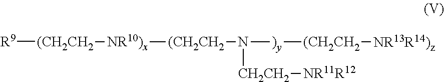

having an average molecular weight (Mw) of 200 to 2,000,000 g/mol, whereas the residues R⁹ to R¹⁴ independently from each other are hydrogen, linear or branched C₁ to C₂₀ alkyl, alkoxy, polyoxyethylene, hydroxylated alkyl, alkylated carboxy, phosphonoalkyl, alkylated amino, C₂ to C₂₀ alkenyl, or C₆ to C₂₀ aryl, aryloxy, hydroxylated aryl, arylcarboxy or arylamino groups which are optionally further substituted; and whereas R¹² and R¹³ can additionally represent further polyethyleneimine-type polymeric groups and x, y and z independently from each other define 0 or an integer; R⁹ further can be a primary amino group.

The sum of x, y and z is selected to give an average molecular mass in the above-defined range. Preferred ranges for the average molecular weight (Mw) of the polyethyleneimines according to the general formula (V) are 250 to 500,000 g/mol, preferably 300 to 100,000 g/mol.

Preferred residues R⁹ to R¹⁴ are hydrogen, methyl, ethyl, carboxymethyl, carboxyethyl, phosphonomethyl, 2-hydroxy ethyl, 2-(2′-hydroxyethoxy)ethyl and 2-[2′-(2″-hydroxyethoxy)-ethoxy]ethyl and R⁹ preferably is a primary amino group.

In one embodiment, the surfactant potentiator is a branched polyethyleneimine having a nitrogen to carbon ratio of from about 1:4 to about 1:3, such as from about 0.8:2 to about 1.2:2.

In another aspect, the surfactant potentiator can comprise an alkyl polyglucoside. The alkyl polyglucoside, for instance, can be the reaction product of glucose and a fatty alcohol.

Alkyl polyglucosides may have the following chemical structure:

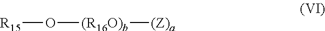

wherein R₁₅ is a monovalent organic radical having from about 6 to about 30 carbon atoms, R₁₆ is a divalent alkylene radical having from 2 to 4 carbon atoms, and Z is a saccharide residue having 5 or 6 carbon atoms, b is a number from 0 to about 12, and a is a number of from 1 to 6.

For instance, the alkyl polyglucoside may have an alkyl group having a carbon chain length of from about C₆ to about C₂₄, such as from about C₆ to about C₁₀. The alkyl polyglucoside may have a degree of polymerization of greater than about 1.3, such as greater than about 1.4, and less than about 1.8, such as less than about 1.7.

In still another embodiment, the surfactant potentiator can comprise a salt of an alkyl or alkenyl ester or diester of a sulfosuccinic acid. The alkyl or alkenyl groups can independently contain from about 6 carbon atoms to about 18 carbon atoms. The compound can be an alkali metal salt, an ammonium salt, a calcium salt, or a magnesium salt. In one embodiment, the surfactant potentiator can comprise sodium dioctylsulfosuccinate or a disodium dioctylsulfosuccinate.

Any of the above surfactant potentiators can be used alone or in combination with any of the other surfactant potentiators. In general, the one or more surfactants of the present disclosure are combined with the one or more surfactant potentiators such that the weight ratio is from about 50:1 to about 1:10, such as from about 20:1 to about 1:5, such as from about 15:1 to about 1:1, such as from about 12:1 to about 2:1. In one aspect, for instance, the one or more surfactants are present in an amount greater than the one or more surfactant potentiators.

The amount of the one or more surfactant potentiators that are contained in the composition can depend upon numerous factors including the type of composition being formulated and the desired result. In general, one or more surfactant potentiators are present in compositions formulated according to the present disclosure in an amount greater than about 1 ppm, such as in an amount greater than about 10 ppm, such as in an amount greater than about 20 ppm, such as in an amount greater than about 30 ppm, such as in an amount greater than about 40 ppm, such as in an amount greater than about 50 ppm, such as in an amount greater than about 60 ppm, such as in an amount greater than about 70 ppm, such as in an amount greater than about 80 ppm, such as in an amount greater than about 90 ppm. The one or more potentiators can be present in the composition in an amount less than about 100,000 ppm, such as less than about 50,000 ppm, such as less than about 10,000 ppm, such as less than about 5,000 ppm, such as less than about 1,000 ppm, such as less than about 800 ppm, such as less than about 600 ppm, such as less than about 400 ppm, such as less than about 200 ppm. In one aspect, relatively great amounts of one or more surfactant potentiators can be present in the composition. For instance, the one or more surfactant potentiators can be present in the composition in an amount greater than about 1,000 ppm, such as greater than about 5,000 ppm, such as greater than about 10,000 ppm.

As described above, the one or more surfactant potentiators when combined with the one or more surfactants can greatly enhance the cleaning abilities of the resulting composition. Optionally, the one or more surfactants and the one or more surfactant potentiators can be combined with an antimicrobial agent. For instance, not only does the blend of the one or more surfactants and the one or more surfactant potentiators have enhanced cleaning properties, but are also highly compatible with many antimicrobial agents.

The composition, for instance, can contain a single antimicrobial agent or a single type of antimicrobial agent or a mixture of different antimicrobial agents. Examples of antimicrobial agents that can be incorporated into the composition include quaternary ammonium compounds, guanidine compounds, mixtures thereof, and the like.

In one embodiment, the composition contains at least one quaternary ammonium compound. For example, in one aspect, the quaternary ammonium compound can have the following chemical structure:

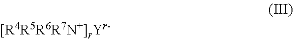

wherein R⁴ is an optionally substituted benzyl group or an optionally substituted alkyl or aryl-substituted alkyl group;
R⁵ and R⁶ are independently optionally substituted alkyl groups;
R⁷ is selected from the group consisting of an optionally substituted alkyl or aryl-substituted alkyl group, benzyl group, and —[(CH₂)₂—O]ₙ—R⁸, wherein n is an integer from 1 to 20 and R⁸ is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.

In one embodiment, the quaternary ammonium compound may comprise a dialkyl ammonium compound, such as a dimethyl dialkyl ammonium compound. In one embodiment, the dimethyl dialkyl ammonium compound may have between about 8 and about 12 carbon atoms, such as from about 8 to about 10 carbon atoms in each of the alkyl groups.

Examples of dimethyl dialkyl ammonium compounds which may be used include dimethyl dioctyl ammonium compounds such as dimethyl dioctyl ammonium chloride, dimethyl didecyl ammonium compounds such as dimethyl didecyl ammonium chloride and the like. Mixtures of dimethyl dialkyl ammonium compounds may also be used and other anions, such as those described above may also be used. Commercially available dimethyl dialkyl ammonium compounds include, for example, compositions marketed and sold under the BARDAC™ tradename by Arxada AG.

In an alternative embodiment, the antimicrobial agent may comprise a benzyl ammonium compound, such as an alkyl dimethyl benzyl ammonium compound. In general, the alkyl group may contain from about 10 to about 18 carbon atoms, such as from about 12 to about 16 carbon atoms.

Examples of alkyl dimethyl benzyl ammonium compounds include C12 alkyl dimethyl benzyl ammonium chloride, C14 alkyl dimethyl benzyl ammonium chloride, and C16 alkyl dimethyl benzyl ammonium chloride. In addition, a mixture of these alkyl dimethyl benzyl ammonium compounds can be used. Commercially available alkyl dimethyl benzyl ammonium compounds include, for example, compositions marketed and sold under the BARQUAT® tradename by Arxada AG. These commercially available alkyl dimethyl benzyl ammonium compounds are blends of C12, C14, and C16 alkyl dimethyl benzyl ammonium chlorides. Generally, it is preferable that the alkyl dimethyl benzyl ammonium compound, when a blend, contains higher concentrations of C12 alkyl and C14 alkyl components than C16 alkyl components. It is noted that other anions, including those mentioned above, may also be used.

In still another embodiment, the quaternary ammonium compound may comprise a quaternary ammonium propionate. The quaternary ammonium propionate, for instance, may comprise a poly(oxyalkyl) ammonium propionate. In one particular embodiment, for instance, the first biocide may comprise N,N-didecyl-N-methyl-poly(oxyethyl) ammonium propionate.

In one aspect, the antimicrobial agent(s) comprises a carbonate/bicarbonate salt of a quaternary ammonium cation. For example, the antimicrobial agent contained in the composition can comprise a di C₈-C₁₂ alkyl ammonium carbonate/bicarbonate. In one particular embodiment, the composition contains didecyldimethylammonium carbonate and/or didecyldimethylammonium bicarbonate.

In other embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

In another aspect, the quaternary ammonium compound can comprise an alkyl trimethyl ammonium compound, such as an alkyl trimethyl ammonium chloride. The alkyl group, for instance, can have a carbon chain length of from about 8 carbon atoms to about 20 carbon atoms. In one particular embodiment, the quaternary ammonium compound can be a trimethyl hexadecyl ammonium ion, such as a trimethyl hexadecyl ammonium chloride.

In another aspect, the antimicrobial agent incorporated into the composition in conjunction with one or more surfactants can be a guanidine compound. For example, any suitable guanidine compound can be incorporated into the composition that displays biocidal activity. In one aspect, for instance, the guanidine compound can be a chlorhexidine. Chlorhexidine is commonly represented by the following formula:

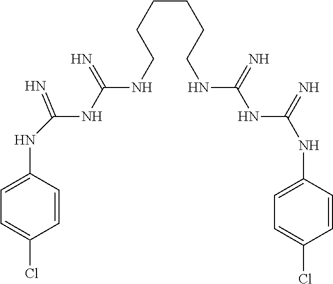 [SMILES: N=C(NCCCCCCNC(=N)NC(=N)Nc1ccc(Cl)cc1)NC(=N)Nc1ccc(Cl)cc1]

In one embodiment, the chlorhexidine may comprise a chlorhexidine salt. For example, the antimicrobial agent may comprise chlorhexidine gluconate, chlorhexidine hydrochloride, or chlorhexidine acetate.

In addition to quaternary ammonium cations and/or a quanidine, the antimicrobial agent may comprise an amine. The amine can be present alone or in combination with the other antimicrobial agents.

Suitable amines include, but are not limited to, tertiary amines, such as (C6-C16)alkyl amines. The term “(C6-C16)alkyl amine” encompasses all amines which contain a (C6-C16)alkyl group. One (C6-C16)alkyl amine is N,N-bis(3-aminopropyl) dodecylamine.

Other exemplary tertiary amines include, for example, N-(3-aminopropyl)-N-dodecyl propane-1,3-diamine, N-(3-aminopropyl)-N-decyl-1,3-propanediamine, N-(3-aminopropyl)-N-tetradecyl-1,3-propanediamine as well as their acid addition compounds.

As described above, the composition of the present disclosure may contain a single antimicrobial agent, a mixture of two or more antimicrobial agents from a single type of antimicrobial agent or may be a mixture of two or more different types of antimicrobial agents. For example, the composition may contain a single quaternary ammonium compound or a mixture of quaternary ammonium compounds. Alternatively, the composition can contain one or more quaternary ammonium compounds in combination with one or more guanidine compounds and/or amines. In still another aspect, the composition can contain one or more guanidine compounds without containing any other antimicrobial agents.

The amount of the one or more alkoxylated surfactants, the amount of the one or more antimicrobial agents, and the ratio between the different components can vary widely depending upon the particular application, the desired end use, the microorganisms to be controlled, and the like. In one aspect, one or more quaternary and or tertiary alkoxylated fatty amine surfactants can be present in the composition in an amount greater than about 1 ppm, such as in an amount greater than about 10 ppm, such as in an amount greater than about 50 ppm, in an amount greater than about 100 ppm, such as in an amount greater than about 200 ppm, such as in an amount greater than about 300 ppm, such as in an amount greater than about 400 ppm, such as in an amount greater than about 500 ppm, such as in an amount greater than about 600 ppm, such as in an amount greater than about 700 ppm, such as in an amount greater than about 800 ppm, such as in an amount greater than about 900 ppm, such as in an amount greater than about 1,000 ppm, such as in an amount greater than about 1,100 ppm, such as in an amount greater than about 1,200 ppm, such as in an amount greater than about 1,300 ppm, such as in an amount greater than about 1,400 ppm, such as in an amount greater than about 1,500 ppm, such as in an amount greater than about 1,600 ppm, such as in an amount greater than about 1,700 ppm, such as in an amount greater than about 1,800 ppm, such as in an amount greater than about 1,900 ppm, such as in an amount greater than about 2,000 ppm. One or more surfactants are generally present in the composition in an amount less than about 5,000,000 ppm, such as in an amount less than about 1,000,000 ppm, such as in an amount less than about 500,000 ppm, such as in an amount less than about 100,000 ppm, such as in an amount less than about 50,000 ppm, such as in an amount less than about 25,000 ppm, such as in an amount less than about 10,000 ppm, such as in an amount less than about 9,000 ppm, such as in an amount less than about 8,000 ppm, such as in an amount less than about 7,000 ppm, such as in an amount less than about 6,000 ppm, such as in an amount less than about 5,000 ppm, such as in an amount less than about 4,000 ppm, such as in an amount less than about 3,000 ppm, such as in an amount less than about 2,000 ppm, such as in an amount less than about 1,000 ppm, such as in an amount less than about 900 ppm, such as in an amount less than about 800 ppm, such as in an amount less than about 700 ppm, such as in an amount less than about 600 ppm, such as in an amount less than about 500 ppm, such as in an amount less than about 400 ppm, such as in an amount less than about 300 ppm. The above concentrations generally are for a ready-to-use composition but may also cover liquid disinfectant concentrates. Liquid concentrates, however, can contain one or more surfactants in an amount from about 1,000 ppm to about 5,000,000 ppm, including all increments of 100 ppm therebetween.

As explained above, the amount of one or more antimicrobial agents contained in the composition can vary widely depending upon the antimicrobial agent present and various other factors. In one aspect, the antimicrobial agent can be present in a ready-to-use composition such as in an amount less than about 1,000 ppm, such as in an amount less than about 750 ppm, such as in an amount less than about 500 ppm, such as less than about 450 ppm, such as less than about 400 ppm, such as less than about 350 ppm, such as less than about 300 ppm, such as less than about 250 ppm, such as less than about 200 ppm, such as less than about 150 ppm, such as less than about 100 ppm, such as less than about 90 ppm, such as less than about 80 ppm, such as less than about 70 ppm, such as less than about 60 ppm, such as less than about 50 ppm, such as less than about 40 ppm, such as less than about 30 ppm, such as less than about 20 ppm, such as less than about 10 ppm. The one or more antimicrobial agents are generally present in the composition in an amount greater than about 0.01 ppm, such as in an amount greater than about 0.1 ppm, such as in an amount greater than about 1 ppm, such as in an amount greater than about 2 ppm, such as in an amount greater than about 4 ppm, such as in an amount greater than about 5 ppm, such as in an amount greater than about 10 ppm, such as in an amount greater than about 15 ppm, such as in an amount greater than about 20 ppm, such as in an amount greater than about 25 ppm, such as in an amount greater than about 30 ppm, such as in an amount greater than about 40 ppm, such as in an amount greater than about 50 ppm, such as in an amount greater than about 60 ppm, such as in an amount greater than about 70 ppm, such as in an amount greater than about 80 ppm, such as in an amount greater than about 90 ppm, such as in an amount greater than about 100 ppm, such as in an amount greater than about 150 ppm, such as in an amount greater than about 200 ppm, such as in an amount greater than about 250 ppm, such as in an amount greater than about 300 ppm.

The weight ratio between the one or more surfactants and the one or more antimicrobial agents can generally be from about 1:10 to about 50,000:1. In one aspect, the surfactant is present at a greater concentration or in a greater amount than the one or more antimicrobial agents. In various embodiments, the weight ratio between the surfactant and the one or more antimicrobial agents can be from about 1:1 to about 5,000:1, such as from about 10:1 to about 5,000:1, such as from about 10:1 to about 3,000:1. In particular embodiments, the weight ratio between the surfactant and the one or more antimicrobial agents can be from about 10:1 to about 500:1, such as from about 20:1 to about 400:1, such as from about 100:1 to about 300:1. The above weight ratios, however, are for exemplary purposes only and are not intended to limit the broader aspects of the invention.

Particular and dramatic synergistic effect has been observed when the one or more surfactants and one or more surfactant potentiators of the present disclosure are combined with one or more quaternary ammonium compounds in a composition. Thus, when the composition contains one or more quaternary ammonium compounds, the ready-to-use composition can contain one or more quaternary ammonium compounds at concentrations well below about 500 ppm, such as below about 250 ppm, such as well below about 100 ppm, such as less than about 50 ppm, such as less than about 40 ppm, such as less than about 30 ppm, such as less than about 20 ppm, such as less than about 10 ppm. For example, very effective compositions can be formulated in accordance with the present disclosure in which the composition contains one or more quaternary ammonium compounds at a concentration of from about 0.5 ppm to about 20 ppm, such as from about 1.5 ppm to about 8 ppm. The one or more surfactants can be present in the composition in relation to the at least one quaternary ammonium compound at a weight ratio of from about 1:10 to about 4,000:1, such as from about 20:1 to about 2,000:1, such as from about 150:1 to about 1,000:1.

In one aspect, the composition can contain at least one dimethyl dialkyl ammonium chloride, such as didecyl dimethyl ammonium chloride. In one aspect, the composition can contain octyl decyl dimethyl ammonium chloride, dioctyl dimethyl ammonium chloride, and didecyl dimethyl ammonium chloride.

In an alternative embodiment, the composition can contain one or more surfactants and one or more surfactant potentiators in combination with an alkyl dimethyl benzyl ammonium chloride. For instance, the composition can contain tetradecane dimethyl benzyl ammonium chloride, dodecane dimethyl benzyl ammonium chloride, and hexadecane dimethyl benzyl ammonium chloride.

In still another aspect, the one or more surfactants and one or more surfactant potentiators can be combined with a quaternary ammonium carbonate and/or bicarbonate in order to form the composition. For example, the quaternary ammonium compound can be a blend of didecyl dimethyl ammonium carbonate and didecyl dimethyl ammonium bicarbonate. In addition to being an effective antimicrobial agent, quaternary ammonium carbonates and bicarbonates are also corrosion inhibitors.

In another aspect, the composition contains a guanidine in combination with the one or more surfactants and one or more potentiators. The guanidine, for instance, can be a chlorohexidine. In one aspect, the surfactant can be present in relation to the chlorohexidine at a weight ratio of from about 1:10 to about 8,000:1, such as from about 5:1 to about 2,000:1.

As described above, the composition of the present disclosure can be formulated, in one aspect, as a liquid concentrate that can be diluted with a solvent prior to use. In the liquid concentrate, the amount of the antimicrobial agent will be higher than typical final use amounts.

Dilution of the concentrate will typically be with an aqueous solvent prior to use. One particular aqueous solvent which can be used is water. Dilution can be any amount of the solvent needed to get the concentrate diluted to a desired level of active ingredient for its intended use. Is typically such that the set amount of the concentrated is added to a specified amount of the solvent. For example, one ounce of the concentrate can be added to a pint of solvent for a 1:16 dilution rate; one ounce of concentrate can be added to a quart of a solvent for a 1:32 dilution rate, one ounce of concentrate can be added to ½ gallon of solvent for a 1:64 dilution rate; one ounce of concentrate can be added to one gallon of water for a 1:128 dilution rate and so one. Likewise metric dilution rates could also be used, for example 10 ml per liter for a 1:100 dilution rate, and the like.

The antimicrobial agent, the one or more surfactants and the one or more potentiators may be combined with various different components. For instance, in one embodiment, a solvent can be present in the product. Generally, the solvent will be a polar solvent such as water, or a water-miscible solvent, such as an alcohol and/or a glycol ether. In addition to water, the composition can further include a water-miscible organic solvent. Examples of water-miscible solvents include ethanol, propanol, benzyl alcohol, phenoxyethanol, isopropanol, diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol mono-n-butyl ether, ethylene glycol dimethyl ether, ethylene glycol diethyl ether, ethylene glycol dibutyl ether, propylene glycol n-butyl ether, tripropylene glycol methyl ether, dipropylene glycol methyl ether, dipropylene glycol butyl ether and combinations thereof.

Additionally, the composition may contain an optional sequestering agent. Sequestering agents include, for example, acetic acid derivative selected from the group consisting of ethylenediaminetetraacetic acid (EDTA), nitrilotriacetic acid (NTA), tetrasodium EDTA. The sequestering agent may also serve to bind other metal ions that may adversely affect the effectiveness of the disinfecting components in the composition. In addition, sequestering agent may also assist in soil removal and/or preventing soil redeposition into the disinfecting composition while in use. The sequestering agents, when present in the concentrate is generally present in an amount up to about 20% by weight, and are typically present in an amount of about 2 to about 8% by weight.

The composition may also contain a pH adjusting agent. Suitable pH adjusting agents include sodium hydroxide, sodium citrate and other similar compounds. In the present invention, the concentrate and the final composition will have a pH in the range of about 6 to about 13. Generally, the composition will be considered a neutral disinfecting composition if the pH is in the range of about 6 to about 8. The composition will be considered an alkaline composition when the pH is in the range of above 8 to about 12.

The composition may optionally further contain corrosion inhibitors, complexing agents, auxiliaries, preservatives, fragrances, colorants and the like. Exemplary corrosion inhibitors include, for example, organic phosphorous compounds and blend of organic phosphorous compounds with a polymeric component. Exemplary auxiliaries include, for example, polyethylene glycol or other similar compounds. Colorants and fragrances may be added provided they do not interfere with the function of the composition and may serve for identifying the composition. Generally, the optional further ingredients will make up less than about 20% by weight of the composition.

The composition may also comprise at least one acid or salt thereof. The acid may be an inorganic acid or an organic acid. In a preferred embodiment the acid is a C1 to C8 carboxylic acid. In a particular embodiment, the acid is a monocarboxylic acid, a dicarboxylic acid, a tricarboxylic acid, or a mixture thereof. In an additional embodiment, the acid is a hydroxyl acid, an aromatic acid, or a mixture thereof. In another additional embodiment, the acid is boric acid, methanesulfonic acid, phosphoric acid, etidronic acid, phytic acid, phosphoacetic acid, N-(phosphonomethyl)iminodiacetic acid, diethylenetriaminepentakis(methylphosphonoic acid), S,S-ethylenediamine-N′N′-disuccinic acid, their alkaline salts, or any mixture thereof.

In some embodiments, the acid is citric acid, phosphoric acid, succinic acid, lactic acid, S,S-ethylenediamine-N,N′-disuccinic acid, 1-hydroxyethane 1,1-diphosphonic acid (HEDP), dipicolinic acid (DPA), methanesulfonic acid (MSA), their alkaline salts, or any mixture thereof.

In one embodiment, the acid is a mixture of acids. In some embodiments, the acid comprises one or more of the following organic acids: citric acid, succinic acid, phosphoric acid, and lactic acid. In another embodiment, the acid comprises one or more of the following acids: citric acid, succinic acid, phosphoric acid, and lactic acid, in combination with another acid. For example, citric acid may be used in combination with ethylenediamine-N,N′-disuccinic acid or its alkaline salt, HEDP, and/or MSA. As another example, succinic acid may be used in combination with ethylenediamine-N,N′-disuccinic acid or its alkaline salt, HEDP, and/or MSA. As another example, phosphoric acid may be used in combination with ethylenediamine-N,N′-disuccinic acid or its alkaline salt, HEDP, and/or MSA. As another example, lactic acid may be used in combination with ethylenediamine-N,N′-disuccinic acid or its alkaline salt, HEDP, and/or MSA.

The composition may include from about 1% by weight to about 5% by weight of an organic acid such as citric acid, succinic acid, phosphoric acid, lactic acid, or any mixture thereof, in combination with another acid. In another aspect, the composition may include from about 1% by weight to about 5% by weight of an organic acid such as citric acid, succinic acid, phosphoric acid, lactic acid, or any mixture thereof, in combination with from about 0.05% by weight to about 5% by weight of another acid. In another embodiment, the composition may include from about 2% by weight to about 4% by weight of an organic acid such as citric acid, succinic acid, phosphoric acid, lactic acid, or any mixture thereof, in combination with from about 0.1% by weight to about 4% by weight of another acid such as ethylenediamine-N,N′-disuccinic acid or its alkaline salt, HEDP, and/or MSA.

Various different compositions can be made in accordance with the present disclosure. The composition may be used, for instance, to clean hard surfaces, to pre-clean sterilize or high-level disinfect instruments, and/or as a hand sanitizer.

In one aspect, the composition of the present disclosure can also be incorporated into laundry detergents, fabric rinses, and other fabric treatments.

When containing an antimicrobial agent, the fabric treatments of the present disclosure are effective for killing pathogens, such as gram negative bacteria, on fabrics/clothes in the pre-wash, wash, or rinse water cycle during the laundry cycle of a washing machine.

The one or more surfactants and one or more surfactant potentiators of the present disclosure are not only well suited for use with antimicrobial agents but can also provide cleaning benefits, such as improved fabric cleaning. Consequently, in one embodiment, a fabric treatment can be constructed in accordance with the present disclosure containing an ethoxylated tertiary amine, an ethoxylated quaternary amine, or mixtures thereof in combination with one or more surfactant potentiators, while also optionally containing an antimicrobial agent.

The fabric treatment or laundry detergent can contain one or more laundry or detergent surfactants in addition to the one or more surfactants and one or more surfactant potentiators of the present disclosure. For instance, when the fabric treatment comprises a laundry detergent, additional surfactants may be present to provide detergent characteristics. For example, in some embodiments, the fabric treatment comprises, by weight of the composition, from about 0%-25% of additional surfactants. These additional surfactants may comprise one or more nonionic, cationic and/or zwitterionic (also called amphoteric) surfactants, and mixtures thereof. Any additional surfactants incorporated into the fabric treatment, however, should be compatible with the one or more surfactants and the one or more surfactant potentiators.

Suitable nonionic surfactants useful herein can comprise any nonionic surfactant well suited for use in liquid and/or solid detergent products. Preferred for use in the liquid fabric treatment are those nonionic surfactants which are normally liquid.

In one aspect, the laundry surfactant component may comprise one or more nonionic surfactants, such as an ethoxylated nonionic surfactant.

Suitable nonionic surfactants for use herein include alcohol alkoxylate nonionic surfactants. Alcohol alkoxylates are materials which correspond to the general formula: R9(CmH2mO)nOH wherein R9 is a C8-C16 alkyl group, m is from 2 to 4, and n ranges from about 2 to 12. Preferably R9 is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, alternatively from about 3 to 10 ethylene oxide moieties per molecule.

The alkoxylated fatty alcohol materials useful in the fabric treatments herein will frequently have a hydrophilic-lipophilic balance (HLB) which ranges from about 3 to 17. In one embodiment, the HLB of this material will range from about 6 to 15, alternatively from about 8 to 15. Alkoxylated fatty alcohol nonionic surfactants have been marketed under the tradenames Neodol and Dobanol by the Shell Chemical Company.

Non-limiting examples of nonionic surfactants useful herein include: a) C12-C18 alkyl ethoxylates; b) C6-C12 alkyl phenol alkoxylates wherein the alkoxylate units are a mixture of ethyleneoxy and propyleneoxy units; c) C12-C18 alcohol and C6-C12 alkyl phenol condensates with ethylene oxide/propylene oxide block polymers; d) C14-C22 mid-chain branched alcohols, BA, as discussed in U.S. Pat. No. 6,150,322 which is incorporated by reference herein; e) C14-C22 mid-chain branched alkyl alkoxylates, BAEx, wherein x 1-30; f) Alkylpolysaccharides, such as alkylpolyglycosides; g) polyhydroxy fatty acid amides; and h) ether capped poly(oxyalkylated) alcohol surfactants.

In one aspect, however, the fabric treatments of the present disclosure are substantially free of certain nonionic surfactants and/or anionic surfactants, such as certain ethoxylated nonionic surfactants including linear alcohol ethoxylates and liner alkyl sulphonates. Certain nonionic surfactants, such as linear alcohol ethoxylates and linear alkyl sulphonates (e.g. linear alkyl benzene sulphonates), may interfere with the antimicrobial properties of the antimicrobial agents provided herein. Accordingly, in certain embodiments where the antimicrobial agent comprises a quaternary ammonium compound, the fabric treatment may be absent of nonionic surfactants or of certain nonionic surfactants that may disable or interfere with the antimicrobial properties of certain quaternary ammonium compounds. In some embodiments, the fabric treatment may be substantially free of linear alcohol ethoxylates and linear alkyl benzene sulphonates.

In one aspect, the fabric treatment may contain an amphoteric surfactant. Several non-limiting examples of amphoteric surfactants useful herein include beta-n-alkylaminopropionic acids, n-alkyl-beta-iminodipropionic acids, imidazoline carboxylates, amine oxides, sultaines, betaines, phosphocholines, propionates, di-propionates, sodium cocoamphoacetate, disodium cocoamphodiacetate, 3-[(3-Cholamidopropyl)dimethylammonio]-1-propanesulfonate (CHAPS), dipalmitoylphosphatidylcholine (DPPtdCho), sodium lauroamphocetate and any combinations of any of the foregoing.

Several non-limiting examples of amine oxides include octyl dimethyl amine oxide (i.e. Barlox 8S), decyl dimethyl amine oxide (i.e. Barlox 10S), lauryldimethylamine oxide (i.e. Barlox® 12), cocoalkyldimethyl amine oxide, myristyldimethyl amine oxide (i.e. Barlox® 14), octyldimethyl amine oxide, decyldimethyl amine oxide, lauryldimethyl amine oxide, isoalkyl dimethyl amine oxide tetradecyldimethylaminoxide and cetyldimethyl amine oxide. Several non-limiting examples of betaines include lauramidopropyl betaine, cocamidopropyl betaine (i.e. and Dehyton® PK45), lauramidopropyl betaine, cetyl betaine, oleamidopropyl betaine and ricinoleamidopropyl betain. Several non-limiting examples of sultaines include cocamidopropyl hydroxysultaine, lauramidopropyl hydroxysultaine, cocamidopropyl hydroxysultaine, oleamidopropyl hydroxysultaine, tallowamidopropyl hydroxysultaine, erucamidopropyl hydroxysultaine and lauryl hydroxysultaine. Several non-limiting examples of phosphocholines include dodecylphosphocholine. Several non-limiting examples of propionates include β-Alanine, N-(2-carboxyethyl)-, N-coco alkyl derivatives. Several non-limiting examples of di-propionates include disodium capryloamphodipropionate and disodium cocoamphodipropionate.

Particular laundry or detergent surfactants that may be incorporated into the fabric treatment include a C12 to C15 alcohol ethoxylate, an alcohol ethoxysulfate, a C10 to C16 alkyl dimethyl amine oxide, a C12 to C16 pareth, a C14 to C15 pareth, a C10 to C16 pareth, a polyethylene glycol ether, a salt of a fatty acid, a monoethanol amine alkylbenzene sulfonate, such as monoethanol amine dodecylbenzene sulfonate, a monoethanolamine alkyl benzene sulfonic acid, such as a C10 to C16 alkylbenzene sulfonic acid, a monoethanolamine laureth sulfate, a sodium alkylbenzene sulfonate, such as a sodium C10 to C16 alkylbenzene sulfonate, a sodium lauryl sulfate, or mixtures thereof.

The fabric treatments of the present disclosure may have a viscosity in the range of from water thin (e.g. 1 mPa s) to about 12,000 mPa·s (milli Pascal seconds), or alternatively in the range of from about 150 to about 5,000 mPa·s. The fabric treatments herein may be in the form of a gel, pourable gels, non-pourable gels, liquid, or heavy-duty liquids.

“Gel” as used herein includes a shear thinning gel with a pouring viscosity in the range of from 1,000 to 5,000 mPa·s, in one embodiment less than 3,000 mPa·s, alternatively less than 1,500 mPa·s. Gels may include thick liquids. More generally, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick under low shear (e.g., at rest) and thin at high flow rates.

Other compositions according to the present disclosure are pourable gels having a viscosity of at least 1,500 mPa·s but no more than 6,000 mPa·s, in one embodiment no more than 4,000 mPa·s, alternatively no more than 3,000 mPa·s, alternatively no more than 2,000 mPa·s.

Yet other compositions according to the present disclosure are non-pourable gels having a viscosity of at least 6,000 mPa·s but no more than 12,000 mPa·s, in one embodiment no more than 10,000 mPa·s, alternatively no more than 8,000 mPa·s and especially no more than 7,000 mPa·s.

In some embodiments, the fabric treatments herein include heavy-duty liquid laundry detergents for use in the wash cycle of automatic washing-machines and liquid fine wash and/or color care detergents; these suitably have the following rheological characteristics: viscosity of no more than 1,500 mPa·s, in one embodiment no more than 1,000 mPa·s, alternatively, no more than 500 mPa·s. Very suitable compositions have viscosity of from 150 to 400 mPa·s and are either Newtonian or shear-thinning.

In these definitions and unless specifically indicated to the contrary, all stated viscosities are those measured at a shear rate of 21 s−1 and at a temperature of 25° C. Viscosity herein can be measured with any suitable viscosity-measuring instrument, e.g., a Carrimed CSL2 Rheometer at a shear rate of 21 sec−1.

The fabric treatment compositions of the present disclosure may also contain suitable enzymes. In certain embodiments, the compositions of the present disclosure may contain less than about 1% of enzymes, alternatively, the compositions of the present disclosure may be substantially free of enzymes. As used herein “substantially free of enzymes” means that no enzymes are purposefully added to the formulation, but yet it is understood to one of ordinary skill in the art that trace amounts of enzymes may be present as impurities in other additives.

Where the compositions herein do contain enzymes, the enzyme can comprise proteases, amylases, cellulose enzymes, lipases, mannanases, pectate lyases, subtilisin, and mixtures thereof. Examples of acid proteases include Promod® 24L, 144L and 671 L produced by Biocatalysts, and Protease A and Protease B produced by Amano and GC 106 and Fungal Acid Protease 500000 produced by Genencor. Other acid proteases are disclosed in U.S. Pat. Nos. 6,066,610 and 6,376,449. Amylases found to be functional under acidic washing conditions include Duramyl, Fungamyl and Natalase produced by Novozymes.

The fabric treatment compositions of the present disclosure may contain one or more additional laundry adjuncts such as dyes, hueing dyes, chelants, stabilizers, radical scavengers, perfumes, fluorescent whitening agents, suds-supressors, soil-suspension polymers, soil release polymers, dye-transfer inhibitors, fabric softening additives, rheology modifiers, and other polymers.

The fabric treatment compositions of the present disclosure may contain a dye to either provide a particular color to the composition itself (non-fabric substantive dyes) or to provide a hue to the fabric (hueing dyes). In one embodiment, the compositions of the present disclosure may contain from about 0.0001 to about 0.01% of a non-fabric substantive dye and/or a hueing dye.

Examples of hueing dyes useful herein include Basic Violet 3 (CI 42555) and Basic Violet 4 (CI 42600), both commercially available from Standard Dyes.

The fabric treatment compositions of the present disclosure may contain a bleaching agent. In one embodiment, the compositions of the present disclosure may contain from about 0.10% to about 10%, by weight of the composition, of a bleaching agent. Bleaching agents useful herein include hydrogen peroxide or peroxyacids such as 6-phthalimidoperoxyhexanoic acid.

The fabric treatment compositions of the present disclosure may contain a chelant. Chelants useful herein include DTPA, HEDP, DTPMP, a citrate, EDTA, IDS, dipicolinic acid, and mixtures thereof.

The fabric treatment compositions of the present disclosure may contain a radical scavenger to provide stability. Radical scavengers useful herein include trimethoxybenzoic acid.

The fabric treatment compositions of the present disclosure may contain a fluorescent whitening agent. Fluorescent whitening agents useful herein include Tinopal CBS-X.

The fabric treatment compositions of the present disclosure may contain a suds suppressor. In one embodiment, the suds suppressor is a non-fatty acid suds suppressor. Examples of non-fatty acid suds supressors useful herein include silica/silicone type, silicone oil, alcohols such as branched alcohols, dimethicone, and mixtures thereof.

The fabric treatment compositions of the present disclosure may contain a soil suspension polymer. In one embodiment, the soil suspension polymer is selected from PEI ethoxylates, HMDA diquate ethoxylates, sulfonated derivatives, hydrophobically modified copolymers. Particularly preferred are PEI with MW=182 and an average degree of ethoxylation=15, PEI with MW=600 and an average degree of ethoxylation=20, hexamethylenediamine dimethyquat with an average degree of ethoxylation=24, and hexamethylenediamine dimethyquat with an average degree of ethoxylation=24 (disulfonated). In one aspect, the soil suspension polymer comprises diethylenetriamine pentaacetate, a modified cellulose, a polyvinyl alcohol such as PEG-136 polyvinyl alcohol, a propoxylated ethoxylated amine, a C12 to C18 sodium salt of a fatty acid, or mixtures thereof.

The fabric treatment compositions of the present disclosure may contain a soil release polymer. In one embodiment, the soil release polymer is a PET alkoxylate short block copolymer.

The fabric treatment compositions of the present disclosure may contain a dye transfer inhibitor and/or a dye fixative. Examples of dye transfer inhibitors useful herein include polyvinylpyrrolidone, poly-4-vinylpyridine-N-oxide, copolymers of N-vinyl-2-pyrrolidone and N-vinylimidazole and mixtures thereof.

In one aspect, the fabric treatment compositions of the present disclosure may contain a fabric softening additive. Examples of fabric softening additives useful herein include alkyl quaternary ammonium compounds, ester quaternary ammonium compounds, bentonite, silicones, cationic silicones, and mixtures thereof.

The fabric treatment compositions of the present disclosure may also contain a rheology modifier. Rheology modifiers useful herein include methylcellulose, hydroxypropylmethylcellulose, xanthan gum, gellan gum, guar gum and hydroxypropyl guar gum, succinoglycan, and trihydroxystearin. Particularly preferred are methylcellulose and hydroxypropylmethylcellulose thickeners available under the Methocel® trade name from Dow Chemical. When used herein, the detergent compositions of the present disclosure contain from about 0.01 to about 1%, by weight of the composition, of a rheology modifier. In one embodiment, the compositions herein contain from about 0.02 to about 0.75%, alternatively from about 0.05% to about 0.5%, by weight of the composition, of the rheology modifier.

The fabric treatment or laundry detergent of the present disclosure can also contain various wash or cleaning adjuvants. Possible wash or cleaning adjuvants include ethanol amine citrate, ethanol amine laurate, ethanol amine palmitate, ethanol amine oleate, ethanol amine stearate, C16 to C18 fatty acids, C18 unsaturated fatty acids, pentasodium pentetate, sodium laurate, sodium lauryl sulfate, sodium myristate, sodium oleate, sodium palmitate, sodium polyacrylate, sodium stearate, and mixtures thereof.

The fabric treatment or laundry detergent composition of the present disclosure can also contain various stabilizers and blending aids including calcium formate, diethylene glycol, dipropylene glycol, an alcohol, ethanol amine, glycerin, hydrogenated castor oil, monoethanol amine citrate, polyethylene glycol, sodium bisulfite, sodium carbonate, sodium citrate, sodium cumene sulfonate, sodium formate, sodium silicate, trimethylsiloxy silicate, or mixtures thereof.

The fabric treatment of the present disclosure can eliminate from about 50% to about 100% of the pathogens present on a fabric, such as soiled laundry. In some embodiments, the fabric treatment provided herein reduces the pathogenic load by eliminating of at least about 99.9% of the pathogens present on the fabrics. By “eliminating” is it understood and meant that the pathogens present are destroyed or have had their pathogenic threat destroyed or disabled. For example, elimination of pathogens may include disabling the ability of the pathogen to pose a pathogenic threat.

Provided herein are methods of laundering fabrics to provide reduction of pathogens from the laundered fabrics, where the method includes: a) introducing a fabric treatment to a wash water that can include a rinse water.

In one aspect, provided herein is a method for laundering fabrics comprising: placing the fabrics in a washing machine; running a laundry cycle on the fabrics in the washing machine, wherein the laundry cycle comprises a wash cycle having wash water and a rinse cycle having rinse water; providing a fabric treatment in accordance with the present disclosure to the washing machine during either the wash cycle or rinse cycle; and removing the fabrics from the washing machine upon completion of the laundry cycle.

When used as a hard or soft surface cleaner, the composition can be delivered to a surface to be cleaned, sanitized or disinfected by conventional means such as pouring the composition on a surface; a spray; which is applied to a surface via a spray means, including but not limited to, pump spray applicators, pressurized spray applicators and the like; a saturated wipe; a rag and a bucket; a mop and bucket; a sponge and a bucket; or via automated cleaning equipment and other similar and conventional ways to apply a composition to a surface for the purposes of sanitizing or disinfecting the surface.

To use the composition of the present disclosure, a surface is treated with the substrate by spraying, pouring, wiping or otherwise applying the composition to the surface. Once applied to the surface, the composition is allowed to remain on the surface for a period of time. The composition may be applied to the surface and allowed to dry or may alternatively be dried by wiping the surface with a dry wipe or wiping device.

Surfaces, which may be disinfected with the compositions include, but are not limited to, those located in dairies, homes, health care facilities, swimming pools, canneries, food processing plants, restaurants, hospitals, institutions, and industry, including secondary oil recovery. Hard surfaces, such as glass and polished aluminum, are particularly suited for application. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. The compositions are particularly well suited for application on indirect food contact surfaces, such as cutting boards, utensils, containers, dishes, wash basins, appliances, and countertops. The compositions can be used to sanitize dairy plant equipment, milking machines, milk pails, tank trucks, and the like. Areas in hospitals would include beds, gurneys, tables, canisters, toilets, waste cans, stands, cabinets, shower stalls, floors, walls or any other non-porous surface.

One particularly useful application method is to impregnate the composition into a wipe substrate. In this embodiment, the wipe is a single use wipe that is impregnated with the disinfecting composition and is stored in a container that will dispense the wipe to a user. The container with the wipes may contain a single wipe, or several wipes. Suitable containers include a pouch containing a single wipe, such as a moist towelette which is torn open by the user or may be a pouch with a resealable opening containing several wipes in a stacked fashion, a rolled fashion or other suitable formation that would allow a single wipe to be removed from the opening at a time. Pouches are generally prepared from a fluid impervious material, such as a film, a coated paper or foil or other similar fluid impervious materials. In another way to dispense wipes of the present invention is to place the wipe into a fluid impervious container having an opening to access the wipes in the container. Containers may be molded plastic container with lids that are fluid impervious. Generally, the lid will have an opening to access the wipes in the container. The wipe in the container may be in a interleaved stack, such that as a wipe is removed from the container the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Generally, in the rolled form, the wipe material is feed from the center of the rolled material. As with the interleaved stack, as a wipe is removed from the container, the next wipe is positioned in the opening for the use to remove the next wipe, when needed.

The disinfecting composition can be impregnated into the wipe such that the wipe is pre-moistened and will express or release the disinfecting composition on to the surface as the wipe is run across the surface to be treated. Generally, the disinfecting composition is saturated into the wipe such that the wipe will release the disinfecting composition to the surface through the wiping action.

Depending on the wipe substrate, saturation was generally achieved using about 3 weight parts of the use disinfecting composition per 1 weight part of the wipe substrate to be saturated. Generally, the disinfecting composition is used from about 4 parts to 6 parts by weight per 1 part by of the wiper substrate. In these ranges, complete saturation of the substrates can be achieved. It is noted that the amount of the disinfecting solution may go up or down to achieve complete saturation of the wipe substrate, depending on the particular wipe substrate.

Suitable wipe substrates include woven and nonwoven materials. Essentially any nonwoven web material may be used. Exemplary nonwoven materials may include, but are not limited to meltblown, coform, spunbond, airlaid, hydroentangled nonwovens, spunlace, bonded carded webs, and laminates thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more.

In one embodiment the wipe is impregnated with a liquid component containing both active and inert ingredients within the allowable tolerance levels and the disinfecting composition expressed from the wipe contains active ingredients within the allowable tolerance levels. Once applied to the surface, the disinfecting composition is allowed to remain on the surface for a period of time. The composition may be applied to the surface and allowed to dry or may alternatively be dried by wiping the surface with a dry wipe or wiping device, which is preferably unused.

When the wipe or disinfecting composition of the present invention is used to wipe a surface, disinfection is achieved in less than 4 minutes, generally 3 minutes or less, 90 seconds or less, or even 60 seconds or less. It will be understood by those of ordinary skill that the antimicrobial disinfecting composition remains in contact with the surface requiring disinfection for a time sufficient to cause disinfection to occur.

In yet another embodiment, the composition may be used as a hand sanitizer. When used as a hand sanitizer, the antimicrobial agents of the present disclosure can be combined with any of the ingredients described above. In one embodiment, for instance, the antimicrobial agents may be combined with a solvent, such as water and/or an alcohol. In one particular application, a foaming agent may be added that causes the composition to foam when pumped from a dispenser. The foaming agent may comprise any suitable foaming agent that is compatible with the antimicrobial agents. In one embodiment, for instance, the foaming agent may comprise a dimethicone or other similar agents that may cause the hand sanitizer to foam.

In one embodiment, the composition may be used for disinfection of instruments, such as for pre-cleaning and disinfection or for terminal, high-level disinfection of a device, medical instrument or endoscope. In one embodiment, when the instrument is treated in a manual process, the composition can be applied by immersing the instrument in the appropriate concentration of the composition. For instance, plastic or metal containers, stainless steel sinks, or any other suitable container may be used as a vessel to hold the composition. In one embodiment, complete immersion of the instrument or device or endoscope, including voids, lumens and hollow sections, may be necessary. When used for disinfection of instruments such as endoscopes, the channels of the endoscope and other instruments may need to be flushed. In general, after disinfection the instrument must be rinsed and flushed thoroughly with water, preferably with significant quantities of water.

Various different microorganisms may be killed or controlled in accordance with the present disclosure. For instance, the composition of the present disclosure can control gram positive bacteria, gram negative bacteria, and the like. In addition to bacteria, the composition of the present disclosure can also kill and control the growth of various other microorganisms, such as viruses, fungi, spores, mycobacteria, and the like. Examples of particular microorganisms that may be killed or controlled in accordance with the present disclosure include Staphylococcus aureus, Streptococcus pneumoniae, Pseudomonas aeruginosa, Serratia marcescens, Salmonella enteritidis, Neisseria gonorrhoeae, Escherichia coli, Enterococcus hirae, Acinetobacter baumannii, Listeria monocytogenes, Pluralibacter gergoviae, Klebsiella pneumoniae, Burholderia cepacia, Pseudomonas putida, Kocuria rhizophila, Candida albicans, Saccharomyces cerevisiae, Aspergillus brasiliensis, Penicillium funiculosum, Eupenicillium levitum, Bacillus cereus, Bacillus subtilis, Clostridium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof.

As described above, the surfactant of the present disclosure in combination with one or more surfactant potentiators can improve the wetting and cleaning properties of the composition without decreasing the efficacy of the one or more antimicrobial agents. For example, the composition of the present disclosure can exhibit at least a 2 log reduction, such as a 3 log reduction, such as a 4 log reduction, such as even a 5 log reduction against any of the microorganisms identified above when tested according to Test EN1276 after a contact time of 60 seconds, 30 seconds, or even 20 seconds or according to Test EN1650 after a contact time of 5 minutes. Both tests can be conducted with distilled water. Further, it was unexpectedly discovered that the efficacy of the antimicrobial agent is not decreased in the presence of the surfactant in combination with one or more surfactant potentiators. In other words, the composition is formulated to exhibit a log reduction when tested against a microorganism according to either Test EN1276 (contact time of 60 seconds) or Test EN1650 (contact time of 5 minutes) and wherein the log reduction is no less in comparison to an identical composition not containing the surfactant in combination with one or more surfactant potentiators (surfactant replaced with water). The microorganism can be a bacteria, a virus, a fungi, or the like. In one aspect, the microorganism can be Pseudomonas aeruginosa or Candida albicans.

The present disclosure may be better understood with reference to the following examples. In the examples below, for surfactant mixtures containing an ethoxylated quaternary amine blended with an ethoxylated tertiary amine, the relative amounts of the components was determined by NMR spectroscopy or provided by the manufacturer unless otherwise denoted.

### Example No. 1

The following example demonstrates some of the advantages and benefits of the present disclosure. In the examples below, for surfactant mixtures containing an ethoxylated quaternary amine blended with an ethoxylated tertiary amine, the relative amounts of the components was determined by NMR spectroscopy or provided by the manufacturer unless otherwise denoted.

In this example, various different surfactant potentiators were blended with a surfactant mixture containing an ethoxylated fatty acid tertiary amine combined with an ethoxylated fatty acid quaternary amine. The surfactant potentiator and the surfactant mixture were combined with a washing solution (containing an antimicrobial agent) and tested for their ability to remove stains from a fabric.

The following example demonstrates that the surfactant potentiators of the present disclosure can dramatically and unexpectedly improve the ability of the surfactants to clean and remove an oily particulate substance from a fabric, namely a cotton fabric. Oily substances are generally the most difficult stains or substances to remove from fabrics.

The surfactant potentiators that were tested included (1) a mixture of morpholines; (2) a vinyl pyrrolidone copolymer; (3) a polyacrylate crosspolymer; (4) a polyethyleneimine; (5) an alkylpolyglucoside; and (6) a dialkylsulfosuccinate.

The surfactant mixture used in this example and combined with each of the above surfactant potentiators contained 33% by weight quaternary ethoxylated stearyl-2-hydroxethylamine, chloride, and 67% by weight ethoxylated stearyl-2-hydroxethylamine.

The washing solution that was combined with each surfactant potentiator and the surfactant mixture contained 200 ppm a mixture of 32% by weight of an alkyl dimethyl benzyl ammonium chloride mix (containing a mixture of 50% by weight C14, 10% by weight C16, and 40% by weight C12 dimethyl benzyl ammonium chloride) combined with 24% by weight octyl decyl dimethyl ammonium chloride, 9.6% by weight dioctyl dimethyl ammonium chloride, and 14.4% by weight didecyl dimethyl ammonium chloride; 250 ppm citric acid and 42 ppm triethanolamine.

The surfactant mixture was added to the washing solution at a concentration of 1,000 ppm. Each surfactant potentiator was added to the washing solution at a concentration of 100 ppm. Thus, the surfactant to surfactant potentiator ratio was 10:1.

The following samples were formulated:
Sample No. 1: Mixture of 4-lauryl morpholine, 4-tetradecyl morpholine, and 4-hexadecyl morpholine+surfactant mixture+washing solution;
Sample No. 2: Dimethylaminoethyl methacrylate vinyl pyrrolidone copolymer+surfactant mixture+washing solution;
Sample No. 3: Polyacrylate-1 crosspolymer+surfactant mixture+washing solution;
Sample No. 4: Branched polyethyleneimine having a nitrogen to carbon ratio of 1:2+surfactant mixture+washing solution;
Sample No. 5: C8 to C10 alkylpolyglucosides+surfactant mixture+washing solution;
Sample No. 6: Sodium dioctylsulfosuccinate+surfactant mixture+washing solution; and
Sample No. 7: Control sample only containing the surfactant mixture+washing solution and not containing any surfactant potentiators.

For purposes of comparison, the test was also conducted using a commercial laundry detergent which is specially formulated to remove oily stains. The commercial laundry detergent tested was LYSOL brand anti-bacterial available from Reckitt of Slough, England.

Woven cotton fabrics were tested. The cloths were stained using a mineral oil with carbon black (TestFabric Stain CFT-01-s).

Washing was carried out in a Rotawash M228B/C color fastness tester (SDL Atlas USA, Rock Hill, South Carolina) using large canisters, with 3 replicate stains per pot and 60 mL of diluted product in tap water (226 ppm hardness) at room temperature for one hour using 10 stainless steel beads.

Stain and fabric measurements, before and after washing were made with a BYK Spectro-guide 45/0 gloss spectrophotometer (BYK-Gardner GmbH, Geretsried, Germany). Each unwashed and washed stain was measured 5 times.

The Stain Removal Index (SRI) was calculated as described in ASTM 4265 Standard Guide for Evaluating Stain Removal Performance in Home Laundering.

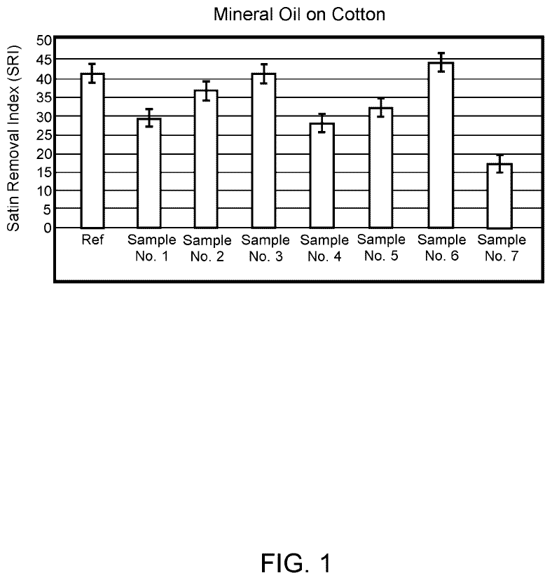

FIG. 1 illustrates the results. As shown, the surfactant potentiators dramatically improved the cleaning properties of the surfactant mixture (compare Sample No. 7 to Samples Nos. 1-6). In fact, the surfactant mixture blended with the surfactant potentiator produced results that were similar to the commercial laundry detergent. These results are completely unexpected, especially considering that the surfactants are cationic.

### Example No. 2

In this example, a suspension test was conducted in order to demonstrate that the surfactant potentiators of the present disclosure do not interfere with the efficacy of antimicrobial agents and can in fact enhance their ability to destroy microorganisms. In particular, various antimicrobial agents were combined and tested with the surfactant potentiators of the present disclosure.

Test compounds were screened using a suspension test. The organism used was Klebsiella pneumoniae subsp. Pneumoniae ATCC 4352. Bacteria were stored at −80° C. using Microbank™ beads (Prolab diagnostics). Cultures were prepared in 250 mL baffled shake flasks with 25 mL of Tryptic Soy Broth (TSB) using one bead. After 18+/−8 hours incubation at 37° C. and 150 rpm, the inocula are prepared for the test.

The inocula was prepared by diluting the bacteria to 2.5×10⁶ CFU/mL in Butterfield's phosphate buffered saline (PBS). Three levels of each test compound were prepared by serial two fold dilution in PBS. For each biological rep, the test compounds were tested at 3 levels in quadruplicate with one quadruplicate control with no test compound.

The test was performed by mixing the test compounds with the inocula (80:20 test compound: inocula) and allowing 1 minute before neutralizing the reaction by 10 fold dilution in Letheen broth. After neutralization of the test, a log reduction was calculated.

Various different antimicrobial agents were tested in combination with three of the surfactant potentiators from Example No. 1. The surfactant potentiators tested included mixture of 4-lauryl morpholine, 4-tetradecyl morpholine, and 4-hexadecyl morpholine; dimethylaminoethyl methacrylate vinyl pyrrolidone copolymer; and sodium dioctylsulfosuccinate. The antimicrobial concentrations were at 500 ppm, 250 ppm, and 125 ppm. The experiments were tested against Klebsiella pneumoniae. The surfactant potentiator concentration was constant at 200 ppm.

In the tables below, the alkyl dimethyl benzyl ammonium chloride mix contained a mixture of 50% by weight C14, 10% by weight C16, and 40% by weight C12 dimethyl benzyl ammonium chloride. The alkyl dimethyl ammonium chloride mix contained 40% octyl decyl dimethyl ammonium chloride, 16% dioctyl dimethyl ammonium chloride, and 24% didecyl dimethyl ammonium chloride. In the tables below, Table No. 1 was conducted without any surfactant potentiator present. Table Nos. 2-4 each contained a surfactant potentiator. Table No. 2 contained Sample No. 1 from Example No. 1, Table No. 3 contained Sample No. 2 from Example No. 1, and Table No. 4 contained Sample No. 6 from Example No. 1. The following results were obtained:

TABLE NO 1

| | | Klebsiella pneumoniae | | |
|---|---|---|---|---|
| | | Log Kill | | |
| | | No surfactant potentiator | | |
| | Amount of antimicrobial | 500 ppm | 250 ppm | 125 ppm |
| 1 | N,N-Didecyl-N-methyl- | 5.00 | 1.44 | 0.25 |
| | poly(oxyethyl) ammonium | | | |
| | propionate | | | |
| 2 | Chlorohexidine\|Didecyl | 5.00 | 2.50 | 0.25 |
| | dimethyl ammonium chloride | | | |
| | (1:1) | | | |
| 3 | Chlorohexidine\|Didecyl | 5.00 | 1.50 | 0.25 |
| | dimethyl ammonium | | | |
| | chloride\|Alkyl dimethyl | | | |
| | ammonium chloride mix | | | |
| | (1:1:1) | | | |
| 19 | Alkyl dimethyl | 5.00 | 1.75 | 0.25 |
| | ammonium chloride | | | |
| | mix\|Chlorohexidine\|Didecyl | | | |
| | dimethyl ammonium | | | |
| | chloride\|Alkyl | | | |
| | dimethyl benzyl | | | |
| | ammonium chloride mix | | | |
| | (5:1:1:1) | | | |

TABLE NO 2

| | | Klebsiella pneumoniae | | |
|---|---|---|---|---|
| | | Log Kill | | |
| | | mixture of 4-lauryl morpholine, | | |
| | | 4-tetradecyl morpholine, and | | |
| | | 4-hexadecyl morpholine | | |
| | | 200 ppm | | |
| | Amount of antimicrobial | 500 ppm | 250 ppm | 125 ppm |
| 1 | N,N-Didecyl-N-methyl- | 5.06 | 5.06 | 5.06 |
| | poly(oxyethyl) ammonium | | | |
| | propionate | | | |
| 2 | Chlorohexidine\|Didecyl | 5.06 | 5.06 | 5.06 |
| | dimethyl ammonium chloride | | | |
| | (1:1) | | | |
| 3 | Chlorohexidine\|Didecyl | 5.06 | 5.06 | 5.06 |
| | dimethyl ammonium | | | |
| | chloride\|Alkyl dimethyl | | | |
| | ammonium chloride mix | | | |
| | (1:1:1) | | | |
| 19 | Alkyl dimethyl | 5.06 | 5.06 | 5.06 |
| | ammonium chloride | | | |
| | mix\|Chlorohexidine\|Didecyl | | | |
| | dimethyl ammonium | | | |
| | chloride\|Alkyl | | | |
| | dimethyl benzyl | | | |
| | ammonium chloride mix | | | |
| | (5:1:1:1) | | | |

TABLE NO 3

| | | Klebsiella pneumoniae | | |
|---|---|---|---|---|
| | | Log Kill | | |
| | | dimethylaminoethyl methacrylate | | |
| | | vinyl pyrrolidone copolymer | | |
| | | 200 ppm | | |
| | Amount of antimicrobial | 500 ppm | 250 ppm | 125 ppm |
| 1 | N,N-Didecyl-N-methyl- | 5.31 | 5.31 | 5.31 |
| | poly(oxyethyl) ammonium | | | |
| | propionate | | | |
| 2 | Chlorohexidine\|Didecyl | 5.31 | 5.31 | 5.31 |
| | dimethyl ammonium chloride | | | |
| | (1:1) | | | |
| 3 | Chlorohexidine\|Didecyl | 5.31 | 5.31 | 4.31 |
| | dimethyl ammonium | | | |
| | chloride\|Alkyl dimethyl | | | |
| | ammonium chloride mix | | | |
| | (1:1:1) | | | |
| 19 | Alkyl dimethyl | 5.31 | 5.31 | 2.31 |
| | ammonium chloride | | | |
| | mix\|Chlorohexidine\|Didecyl | | | |
| | dimethyl ammonium | | | |
| | chloride\|Alkyl | | | |
| | dimethyl benzyl | | | |
| | ammonium chloride mix | | | |
| | (5:1:1:1) | | | |

TABLE NO 4

| | | Klebsiella pneumoniae | | |
|---|---|---|---|---|
| | | Log Kill | | |
| | | sodium | | |
| | | dioctylsulfosuccinate | | |
| | | 200 ppm | | |
| | Amount of antimicrobial | 500 ppm | 250 ppm | 125 ppm |
| 1 | N,N-Didecyl-N-methyl- | 4.75 | 1.75 | −0.25 |
| | poly(oxyethyl) ammonium | | | |
| | propionate | | | |
| 2 | Chlorohexidine\|Didecyl | 5.00 | 5.00 | 0.00 |
| | dimethyl ammonium chloride | | | |
| | (1:1) | | | |
| 3 | Chlorohexidine\|Didecyl | 5.00 | 5.00 | 0.25 |
| | dimethyl ammonium | | | |
| | chloride\|Alkyl dimethyl | | | |
| | ammonium chloride mix | | | |
| | (1:1:1) | | | |
| 19 | Alkyl dimethyl | 5.00 | 5.00 | 0.25 |
| | ammonium chloride | | | |
| | mix\|Chlorohexidine\|Didecyl | | | |
| | dimethyl ammonium | | | |
| | chloride\|Alkyl | | | |
| | dimethyl benzyl | | | |
| | ammonium chloride mix | | | |
| | (5:1:1:1) | | | |

As shown above, the surfactant potentiators of the present disclosure did not interfere with the efficacy of the antimicrobial agents. In fact, the surfactant potentiators actually showed an increase in efficacy during some of the examples.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A composition comprising:
one or more surfactants comprising:
i) an ethoxylated tertiary amine of the general formula (I): 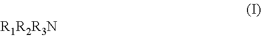
ii) an ethoxylated quaternary amine of the general formula (II): 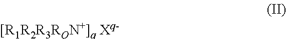
iii) or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4; and
a surfactant potentiator, the surfactant potentiator comprising a morpholine, a vinyl pyrrolidone copolymer, a polyacrylate crosspolymer, a polyalkyleneimine, an alkyl polyglucoside, a salt of an alkyl or an alkylene ester or diester of a sulfosuccinic acid, or mixtures thereof.

2. A composition as defined in claim 1, wherein the surfactant potentiator comprises the morpholine, the morpholine comprising one or more C₆ to C₂₄ alkylmorpholines.

3. A composition as defined in claim 2, wherein the morpholine comprises 4-laurylmorpholine, 4-tetradecylmorpholine, 4-hexadecylmorpholine, or mixtures thereof.

4. A composition as defined in claim 1, wherein the potentiator comprises the vinyl pyrrolidone copolymer, the vinyl pyrrolidone copolymer comprising a vinyl pyrrolidone and dialkylaminoethyl copolymer.

5. A composition as defined in claim 1, wherein the surfactant potentiator comprises the polyacrylic crosspolymer.

6. A composition as defined in claim 1, wherein the surfactant potentiator comprises the polyalkyleneimine.

7. A composition as defined in claim 1, wherein the surfactant potentiator comprises the alkyl polyglucoside, the alkyl polyglucoside comprising a C₆ to a C₂₄ alkyl polyglucoside.

8. A composition as defined in claim 1, wherein the surfactant potentiator comprises the salt of the alkyl or alkylene ester or diester of a sulfosuccinic acid, the salt of the alkyl or alkylene ester or diester of a sulfosuccinic acid comprising a sodium dialkyl sulfosuccinate.

9. A composition as defined in claim 1, wherein the one or more surfactants are present in the composition in relation to the surfactant potentiator at a weight ratio of from about 50:1 to about 1:10.

10. (canceled)

11. (canceled)

12. A composition as defined in claim 1, wherein p is 0; n and m are an integer from 4 to 30; and Rₐ, R_{b}, R_{c}, R_{d}, Rₑ, R_{f} are H.

13. (canceled)

14. (canceled)

15. (canceled)

16. (canceled)

17. (canceled)

18. A composition as defined in claim 1, wherein the composition comprises from about 5% by weight to about 80% by weight of at least one ethoxylated quaternary amine and from about 95% by weight to about 20% by weight of at least one ethoxylated tertiary amine.

19. (canceled)

20. A ready to use composition, comprising:
one or more surfactants comprising:
iv) an ethoxylated tertiary amine of the general formula (I); 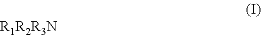
v) an ethoxylated quaternary amine of the general formula (II): 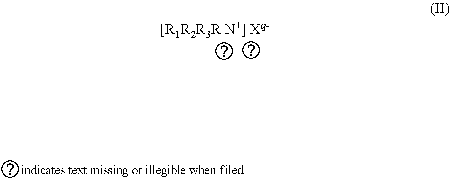
vi) or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group or a CH₂OH group and p is 0 or 1,
X is a counterion selected from the group consisting of species generated from a mineral acid or organic acid, and
q is 1, 2, 3 or 4;
a surfactant potentiator comprising a morpholine, a vinyl pyrrolidone copolymer, a polyacrylate crosspolymer, a polyalkyleneimine, an alkyl polyglucoside, a salt of an alkyl or an alkylene ester or diester of a sulfosuccinic acid, or mixtures thereof; and
wherein the one or more surfactant potentiators are present in the ready to use composition in an amount of greater than about 1 ppm.

21. A ready to use composition as defined in claim 20, wherein the one or more surfactants are present in a ready to use composition in an amount of greater than about 1 ppm, and in an amount less than about 50,000 ppm.

22. A ready to use composition as defined in claim 20, wherein the composition further comprises an antimicrobial agent.

23. A ready to use composition as defined in claim 22, wherein the antimicrobial agent comprises at least one quaternary ammonium compound having the following structure: 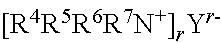
wherein R⁴ is an optionally substituted benzyl group or an optionally substituted alkyl or aryl-substituted alkyl group;
R⁵ and R⁶ are independently optionally substituted alkyl groups;
R⁷ is selected from the group consisting of an optionally substituted alkyl or aryl-substituted alkyl group, benzyl group, and [(CH₂)₂—O]ₙ—R⁸, wherein n is an integer from 1 to 20 and R⁸ is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.

24. A ready to use composition as defined in claim 23, wherein the at least one quaternary ammonium compound comprises an alkyl dimethyl benzyl ammonium chloride, at least one dimethyl dialkyl ammonium chloride, an N,N-dialkyl-N,N-dimethylammonium carbonate and/or N,N-dialkyl-N,N-dimethylammonium bicarbonate.

25. (canceled)

26. (canceled)

27. A composition as defined in claim 23, wherein the at least one quaternary ammonium compound comprises N,N-didecyl-N-methyl-poly(oxyethyl) ammonium propionate.

28. (canceled)

29. (canceled)

30. (canceled)

31. (canceled)

32. (canceled)

33. (canceled)

34. A ready to use composition as defined in claim 22, wherein the antimicrobial agent comprises chlorhexidine, a tertiary amine or mixtures thereof.

35. A ready to use composition as defined in claim 20, wherein the composition comprises as a fabric treatment.

36. A ready to use composition as defined in claim 35, wherein the fabric treatment comprises a laundry detergent.

37. (canceled)

38. A ready to use composition as defined in claim 35, wherein the fabric treatment contains an enzyme, a perfume, a chelant, a radical scavenger, a soil release polymer, a soil suspension polymer, a whiting agent, a rheology modifier, or mixtures thereof.

39. A ready to use composition as defined in claim 35, wherein the composition further comprises a laundry detergent surfactant.

40. A ready to use composition as defined in claim 39, wherein the laundry detergent surfactant comprises an alcohol alkoxylate, an alcohol ethoxy sulfate, an amine oxide, a monoethanolamine alkybenzenesulfonate, a monoethanolamine alkyl benzene sulfronic acid, a monoethanolamine laureth sulfate, a sodium alkylbenzene sulfonate, a sodium lauryl sulfate, or mixtures thereof.
